(19) United States
(12) Patent Application Publication
(10) Pub. No.: US 2026/0236734 A1
(43) Pub. Date: Aug. 13, 2026

(54) MULTI-CONNECTIVITY GRAPH SEGMENTATION METHOD FOR COMPILERS

(71) Applicant: Intel Corporation, Santa Clara, CA (US)

(72) Inventors: Mateusz Darecki, Gdynia PM (PL); Milind Walekar, Cork (IE); Aleksandr Novak, Lucan, Co. Dublin (IE)

(73) Assignee: Intel Corporation, Santa Clara, CA (US)

(21) Appl. No.: 19/432,411

(22) Filed: Dec. 24, 2025

Related U.S. Application Data
(60) Provisional application No. 63/877,482, filed on Sep. 8, 2025.

(51) Int. Cl. G06N 3/04

(52) U.S. Cl. CPC G06N 3/04

(57) ABSTRACT

To improve execution performance of neural network models on hardware accelerators, one or more changes to the compiler can be made to generating fully static schedules for neural network models. By partitioning the processing graph into subgraphs, where adjacent subgraphs use disjoint subsets of hardware barriers and multiple boundary task nodes are allowed for a boundary separating adjacent subgraphs, the compiler can correct execution order and conflict-free reuse of hardware barriers with little impact to the original schedule layout. Moreover, the compiler can insert management operations, such as barrier reprogramming and direct task submission, within the schedule itself. Doing so can eliminate the need for runtime software or firmware to manage execution, reducing latency and enabling better performance.

### PRIORITY APPLICATION

This patent application claims priority to and/or receives benefit from US Provisional Application No. 63/877,482, filed on 8 September 2025, titled “MULTI-CONNECTIVITY GRAPH SEGMENTATION METHOD FOR COMPILERS” (Docket No. AG7340-Z). The US Provisional Application is hereby incorporated by reference in its entirety.

### BACKGROUND

The last decade has witnessed a rapid rise in AI based data processing, particularly based on neural networks (also referred to as “deep neural networks” or “DNNs”). DNNs are widely used in the domains of computer vision, speech recognition, image, and video processing mainly due to their ability to achieve beyond human-level accuracy. A DNN typically includes a sequence of layers. A DNN layer may include one or more deep learning operations (also referred to as “neural network operations”), such as convolution, matrix multiplication, layer normalization, batch normalization, SoftMax operation, pooling, element-wise operation, linear operation, non-linear operation, and so on.

Deep neural network (DNN) accelerators are specialized hardware platforms designed to efficiently execute the computationally intensive operations of DNNs. These accelerators can include arrays of processing elements optimized for parallel multiply-and-accumulate (MAC) operations, local memory for storing activations and weights, and high-bandwidth data paths to facilitate rapid movement of tensors within the device. DNN accelerators achieve significant improvements in throughput and energy efficiency compared to general-purpose central processing units (CPUs) and graphics processing units (GPU). DNN accelerators are widely deployed in applications ranging from cloud datacenters to mobile and edge devices, enabling real-time inference and training for tasks in computer vision, speech recognition, and natural language processing.

### BRIEF DESCRIPTION OF THE DRAWINGS

Embodiments will be readily understood by the following detailed description in ‎conjunction with the accompanying drawings. To facilitate this description, like reference ‎numerals designate like structural elements. Embodiments are illustrated by way of ‎example, and not by way of limitation, in the figures of the accompanying drawings.

FIG. 1 illustrates a computing system having a compiler and a DNN accelerator.

FIG. 2 illustrates a computing system having a compiler and a DNN accelerator.

FIG. 3 illustrates an improved computing system with a compiler and a DNN accelerator, according to some embodiments of the disclosure.

FIG. 4 illustrates multi-connectivity subgraph partitioning or segmentation, according to some embodiments of the disclosure.

FIG. 5 illustrates properties and technical advantages of the approach involving multi-connectivity graph splitting and creation of a fully static schedule, according to some embodiments of the disclosure.

FIG. 6 illustrates a barrier, according to some embodiments of the disclosure.

FIG. 7 illustrates partitioning a processing graph, according to some embodiments of the disclosure.

FIG. 8 illustrates compares execution traces with or without allowing multiple boundary tasks between subgraphs, according to some embodiments of the disclosure.

FIG. 9 illustrates legalization of one or more boundary task nodes, according to some embodiments of the disclosure.

FIG. 10 illustrates adding a barrier reprogramming task node to a subgraph, according to some embodiments of the disclosure.

FIG. 11 illustrates adding one or more data movement task nodes to a subgraph, according to some embodiments of the disclosure.

FIG. 12 is a flow diagram illustrating a method for compiling a neural network model to be executed on a neural network accelerator, according to some embodiments of the disclosure.

FIG. 13 depicts a block diagram of an exemplary computing device, according to some embodiments of the disclosure.

### DETAILED DESCRIPTION

### Overview

Deep Learning (DL) compilers transform DNN models from various DL frameworks, such as TensorFlow or PyTorch, into target-specific formats for CPUs, GPUs, and dedicated DNN accelerators like neural processing units (NPUs). The compilation process may occur in multiple stages, each operating at a different level of abstraction. After a model is imported and converted into a supported Intermediate Representation (IR), it may undergo a series of optimizations. The optimizations can include operations such as fusion, constant folding, quantization, and tiling, which aim at simplifying computations and enabling efficient execution while leveraging the hardware’s capabilities. Memory may then be allocated to operation buffers, and a task schedule may be defined. Finally, the representation may be lowered to a target device binary or a device-specific format, producing the final output ready for execution.

Current DL compiler technologies and execution models usually rely on additional runtime software (SW) or firmware (FW). Beyond loading the binary and initiating execution, this runtime can be responsible for runtime management. Runtime management may include not only handling preemption but also performing scheduling actions, such as loading task descriptors into local fast-access memory, dispatching task descriptors to hardware engine registers, and managing synchronization, for example through programming hardware barriers.

Compilers often generate schedules that require runtime management, which can be classified as dynamic or partially static schedules. In such approaches, execution performance can be constrained by the speed at which runtime software or firmware can respond to hardware events, such as the completion of a task indicated by a barrier. The runtime would then load and dispatch new tasks for execution, which can become a limiting factor in achieving peak hardware performance.

To address this limitation, a fully static schedule is generated at compile-time. By merging the computation graph with the execution management graph during compilation, most dynamic control that would otherwise be handled by runtime software or firmware can be eliminated. The runtime’s role can be reduced to applying the initial configuration, launching the first task, or handling preemption.

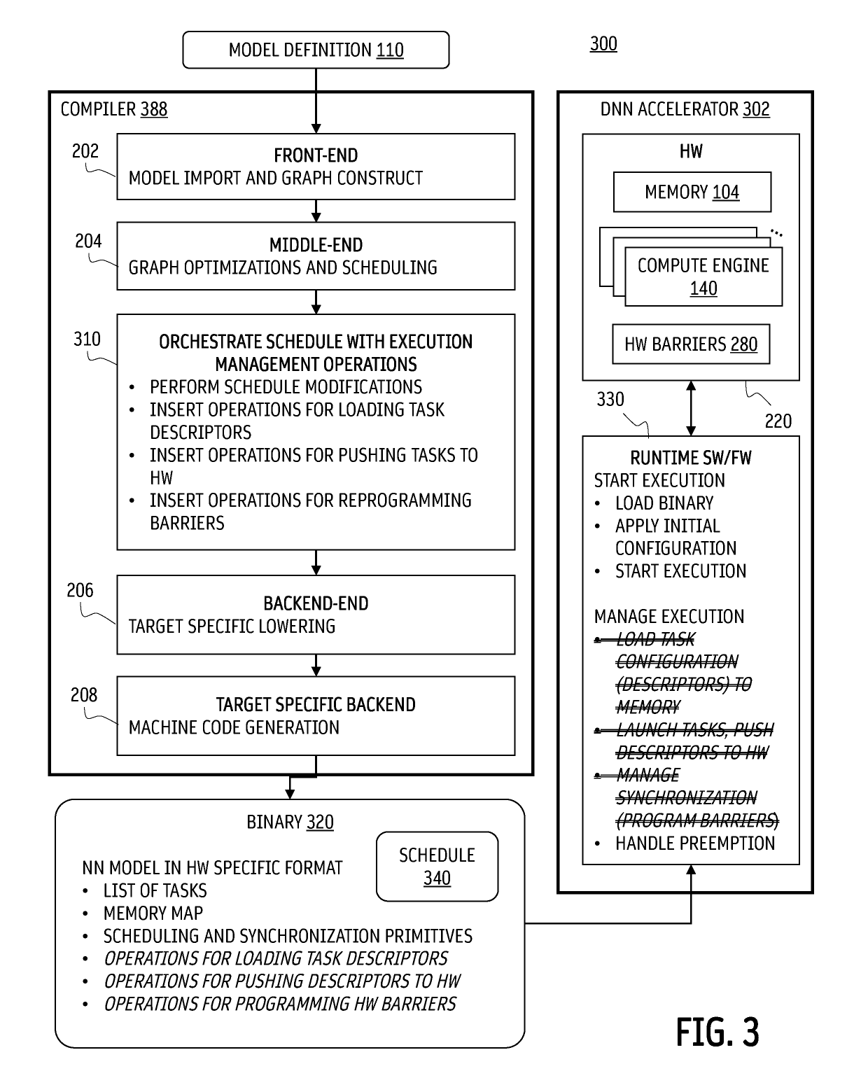

Generating a fully static schedule at compile-time is not trivial. Solutions described and illustrated in FIGS. 3-5 and 7-12 can address one or more of the following challenges, including:
Execution synchronization using a limited number of hardware (HW) synchronization primitives (hardware barriers).
Task submission to hardware engines.
Schedule modification with minimal impact on the original computation graph to avoid performance degradation.

To address these challenges, the solutions described and illustrated in FIGS. 3-5 and 7-12 can implement one or more methods and techniques to modify and orchestrate the schedule while optimizing both compile time and runtime execution. The result is a binary, a binary representation, or a binary file for the neural network model that can be executed on target DNN hardware with low to little runtime management to achieve significant improvements in execution performance.

To improve execution performance of neural network models on hardware accelerators, one or more changes to the compiler can be made to generating fully static schedules for neural network models. By partitioning the processing graph into subgraphs, where adjacent subgraphs use disjoint subsets of hardware barriers and multiple boundary task nodes are allowed for a boundary separating adjacent subgraphs, the compiler can correct execution order and conflict-free reuse of hardware barriers with little impact to the original schedule layout. Moreover, the compiler can insert management operations within the schedule itself. Examples of operations can include barrier reprogramming and direct task submission. Direct task submission can be inserted into the schedule by adding a data movement task to load/push task descriptors onto the local memory of the compute engines. Embedding management operations into the schedule can eliminate the need for runtime software or firmware to manage execution, reducing latency and enabling better performance.

The improved compiler implementing the multi-connectivity graph splitting methodology can enable straightforward, compile-time mapping of operation dependencies to hardware synchronization resources. The methodology can make it possible to generate a fully static schedule that includes embedded task submission and barrier reprogramming operations, eliminating runtime software or firmware involvement during execution. The improved compiler can lead to a dramatic improvement in performance and can reduce execution latency.

Performance comparisons demonstrated that, across a range of neural network models and workloads, using the compilation methods and techniques consistently delivered substantial improvements in execution speed and efficiency over other solutions that produce partially static or dynamic schedules. For smaller models, the entire workload could be programmed at initialization, eliminating runtime bottlenecks and yielding dramatic gains. For larger models, while only a subset of tasks could be programmed upfront, the static schedule still minimized runtime intervention and produced reliable performance enhancements. The approach proved effective for both low-precision and floating-point models, with improvements observed in throughput and latency. Overall, the results confirm that shifting schedule orchestration from runtime software or firmware to compile-time leads to more deterministic execution and better utilization of hardware resources.

### Understanding DL compilation and execution processes

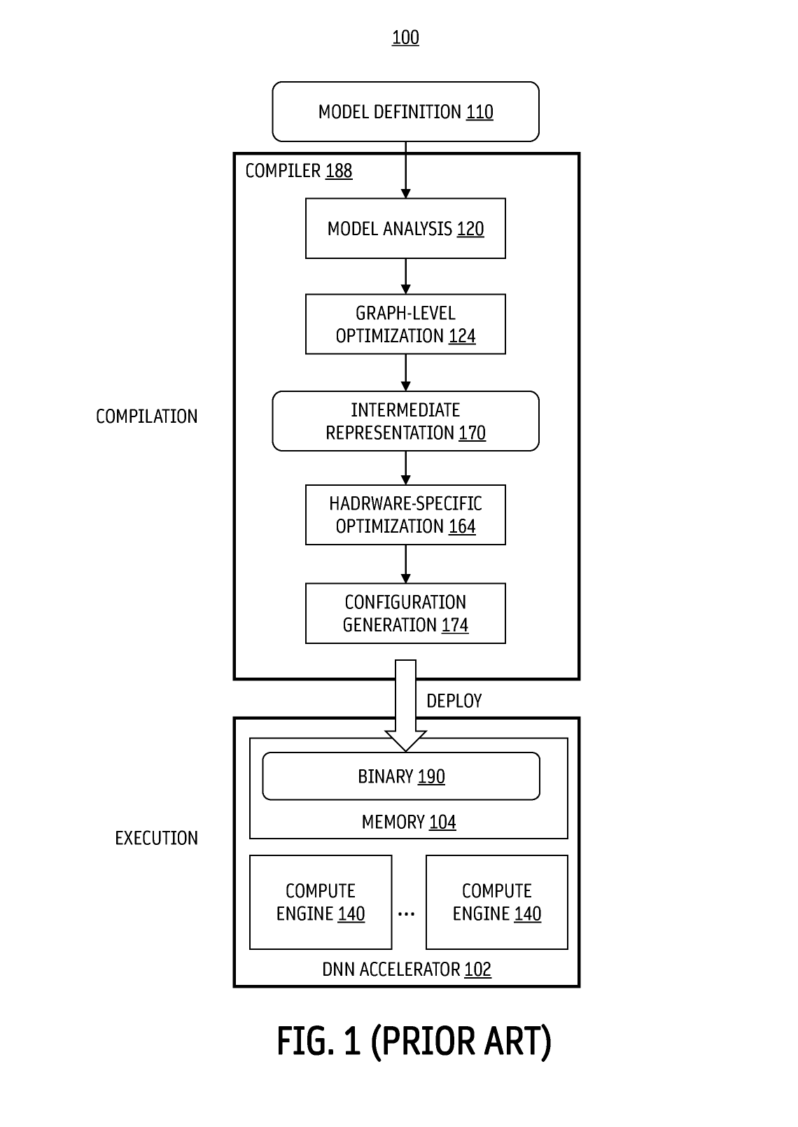

FIG. 1 illustrates computing system 100 having compiler 188 and DNN accelerator 102, according to some embodiments of the disclosure.

Compiler 188 can include one or more of: model analysis 120, graph-level optimization 124, hardware-specific optimization 164, and configuration generation 174. Compiler 188 orchestrates the transformation of model definition 110 into hardware-executable instructions, such as binary 190. Binary 190 can include machine-readable instructions, configurations, and configuration descriptors. Compiler 188 is responsible for analyzing the neural network (e.g., based on information in model definition 110), optimizing its structure, and generating binary 190. Compiler 188 can perform selective mapping of layers to different execution paths of DNN accelerator, to maximizing both accuracy and energy efficiency.

Model definition 110 can include a high-level specification of a deep neural network. Model definition 110 serves as the input to compiler 188. Model definition 110 can include the architectural information of the model, such as the types and sequence of layers (e.g., convolutional, fully connected, normalization, activation), the connectivity between layers, structural information about the dimensionality of inputs and outputs, and the weights of the model. Model definition 110 may specify hyperparameters like kernel sizes, strides, padding, activation functions, and initial weight values. In addition to model details, model definition 110 can include metadata relevant to deployment, such as target accuracy, latency constraints, and resource budgets. This information can allow compiler 188 to tailor optimizations and hardware mappings to meet specific application requirements. Model definition 110 may be expressed in a syntax of a machine learning libraries like TensorFlow or PyTorch. Model definition 110 provides the information for subsequent analysis, profiling, and optimization.

Model analysis 120 can include parsing model definition 110 can produce a graph representation of the neural network. This process involves reading the high-level specification in model definition 110 and converting the specification into a structured computational graph, where nodes represent operations or layers and edges represent data dependencies between them. The resulting graph provides a clear and manipulable format for subsequent optimization and transformation steps within compiler 188. Model analysis 120 accurately translates the model’s architecture specified in model definition 110 into a graph that serves as the foundation for further compilation stages in compiler 188.

Graph-level optimization 124 can include transformations on the computational graph derived from model analysis 120. Graph-level optimization 124 can perform operator fusion, pruning, and reordering to improve computational efficiency and reduce memory usage. Graph-level optimization 124 takes the parsed computational graph from model analysis 120 and applies transformations to improve efficiency and simplify operations, without targeting any specific hardware. Hardware-specific optimization 164 can canonicalize operators, fuse compatible layers, remove redundant or dead computations, and annotate tensors with precision or quantization hints. These optimizations result in IR 170, which is a standardized, compiler-friendly format that encodes the neural network model as a set of normalized operations and typed data flows.

IR 170 can include a hardware-agnostic, lower-level encoding of the neural network, abstracting away framework-specific details. IR 170 serves as the foundation for subsequent hardware-specific optimization and code generation, ensuring the model is both efficient and ready for deployment on various accelerator architectures. IR 170 can serve as a bridge between high-level model description and hardware-specific instructions.

Hardware-specific optimization 164 can receive IR 170 to the constraints and capabilities of DNN accelerator 102. Hardware-specific optimization 164 can identify structural information and statistical information about the various layers and determine whether to map operations of individual layers to which hardware. Hardware-specific optimization 164 can adapt IR 170 of the neural network model to the constraints and capabilities of the target hardware accelerator (in this case, DNN accelerator 102). Hardware-specific optimization 164 can map each operation or layer to the most suitable hardware resources, selects appropriate data precisions, and applies scheduling strategies to maximize performance and efficiency. Hardware-specific optimization 164 may also adjust memory layouts, insert hardware-specific instructions, and fine-tune execution parameters to ensure the compiled model (e.g., binary 190) runs optimally on the target hardware accelerator. Hardware-specific optimization 164 bridges the gap between generic model representation (e.g., IR 170) and the practical requirements of deployment on specialized target hardware accelerators.

Configuration generation 174 can include producing deployment-ready binary 190 for DNN accelerator 102. Binary 190 can include the deployment-ready, machine-readable, instructions and parameters for the neural network accelerator. Binary 190 can include the mapping of each layer to specific hardware resources, routing assignment, scheduling information, memory allocation details, input data shape information, output data shape information, including where to read and write data, operational parameters for the hardware resources, and precision settings. Configuration generation 174 ensures that the execution plan reflects the precision-aware mappings made in hardware-specific optimization 164, with explicit annotations for which layers are to be executed on which circuitry inserted in binary 190.

DNN accelerator 102 can include one or more of: memory 104 and one or more instances of compute engine 140. DNN accelerator 102 can include a data movement engine (or a Direct Memory Access (DMA) engine) that can perform data transfers such as block data transfers between memory 104 and local memory/storage/buffers/registers in compute engine 140.

Memory 104 can include storage for binary 190 and input data, intermediate data, and output data during inference. Memory 104 can hold weights, activations, and runtime parameters for compute engine 140. Memory 104 can store binary 190 generated by compiler 188, which configures compute engine 140 to perform one or more specified operations based on specified data stored in memory 104 and generates data to be stored in memory 104.

Compute engine 140 can include specialized hardware units for performing neural network operations, such as matrix multiplication, convolution, and activation functions. Compute engine 140 can execute operations for layers assigned by compiler 188. Compute engine 140 may be instantiated multiple times within DNN accelerator 102 to support parallel execution and offer different execution paths for different layers. Compute engine 140 can include local storage/memory to store instructions and/or configuration descriptors usable to carry out neural network (NN) operations. Compute engine 140 can include local storage/memory to store tensor data representing inputs, intermediate inputs, intermediate outputs, and outputs of the NN operations. Tensor data can include activations, weights, output feature maps, etc.

One or more instances of compute engine 140 may perform compute operations for neural network models through different hardware architectures. For example, an instance of compute engine 140 may include an application-specific integrated circuit (ASIC) to perform operations with high efficiency. An instance of compute engine 140 may include a digital signal processor (DSP) for specialized operations. An instance of compute engine 140 may include a vector processor for parallel data handling and processing. An instance of compute engine 140 may include analog compute-in-memory (ACiM) circuitry to perform computation directly within memory arrays. An instance of compute engine 140 may include digital compute-in-memory (DCiM) circuitry to perform computation directly within memory arrays higher-precision. An instance of compute engine 140 may include single instruction multiple data (SIMD) compute units. An instance of compute engine 140 can include a systolic array for highly parallel and high-throughput data processing.

During operation, DNN accelerator 102 receives binary 190 from compiler 188 and executes the neural network according to binary 190. Specifically, binary 190 configures DNN accelerator 102 to perform operations of the neural network model, according to the mapping determined by compiler 188. DNN accelerator 102 can dynamically route data between instances of compute engine 140 or within an instance of compute engine 140 based on binary 190, optimizing for both accuracy and energy efficiency.

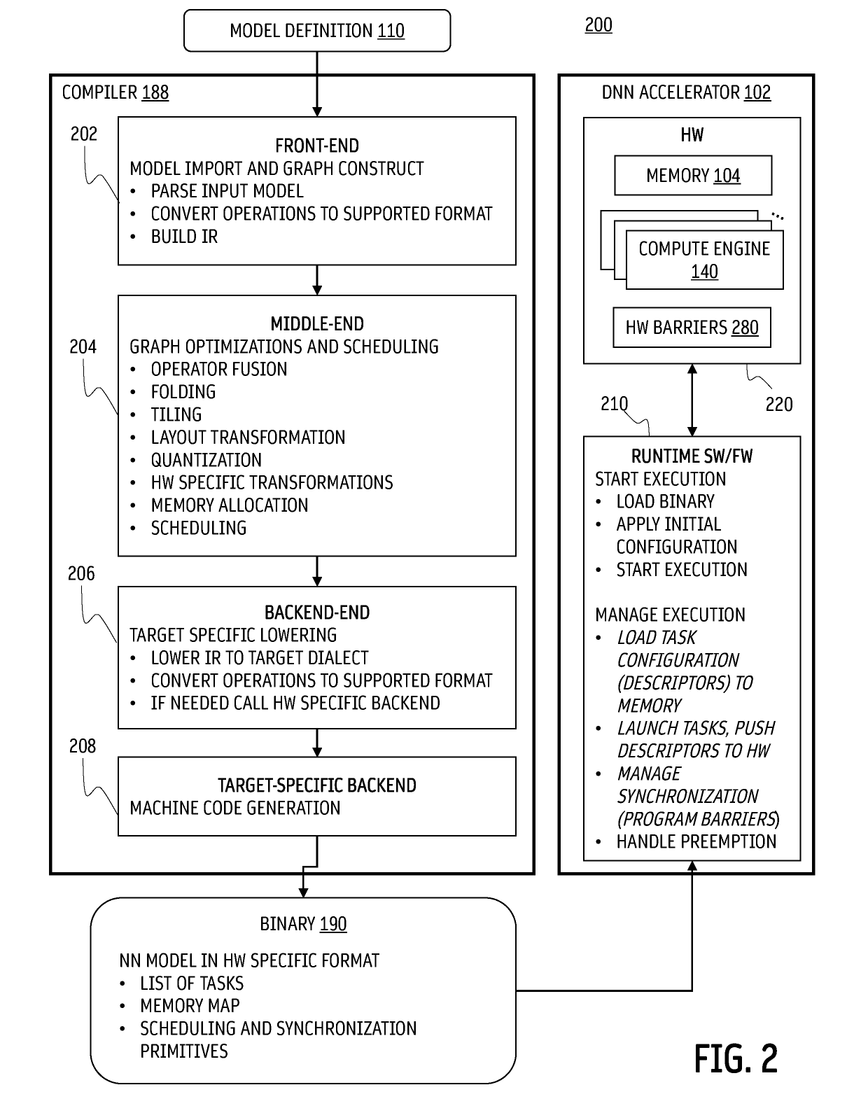

FIG. 2 illustrates computing system 200 having compiler 188 and DNN accelerator 102. The compilation process and the execution process are illustrated in greater detail, with a breakdown of compilation stages and runtime execution operations.

Model definition 110 provides the initial neural network model specification that serves as input to compiler 188.

Compiler 188 comprises one or more of: front-end 202, middle-end 204, backend-end 206, and target-specific backend 208. Compiler 188 receives model definition 110 and processes it through sequential compilation stages.

Front-end 202 can include model import and graph construct logic. The logic can perform one or more of: parse the input model, convert operations to a supported format, and build IR. Front-end 202 transforms the input model into a graph structure, referred to herein as a processing graph corresponding to a neural network model and prepares it for further optimization.

Middle-end 204 can include graph optimization and scheduling logic. The logic can perform one or more of: operator fusion, folding, tiling, layout transformation, quantization, hardware-specific transformations, memory allocation, and scheduling. Middle-end 204 refines the processing graph to improve computational efficiency and adapts it for hardware constraints.

Backend-end 206 can include target-specific lowering logic. The logic can perform one or more of: IR conversion to target dialect, operation conversion to supported format, and invocation of hardware-specific backend if needed. Backend-end 206 translates the optimized graph into a format suitable for the target hardware.

Target-specific backend 208 can include machine code generation logic. Target-specific backend 208 produces executable code tailored for the hardware accelerator to form binary 190..

Binary 190 encapsulates instructions/configurations for the execution of a neural network model in hardware-specific format. Binary 190 can include one or more of: list of tasks, memory map, and scheduling and synchronization primitives. Binary 190 represents the final output, ready for deployment on the DNN accelerator 102.

DNN accelerator 102 comprises one or more of: HW 220 and runtime SW/FW 210.

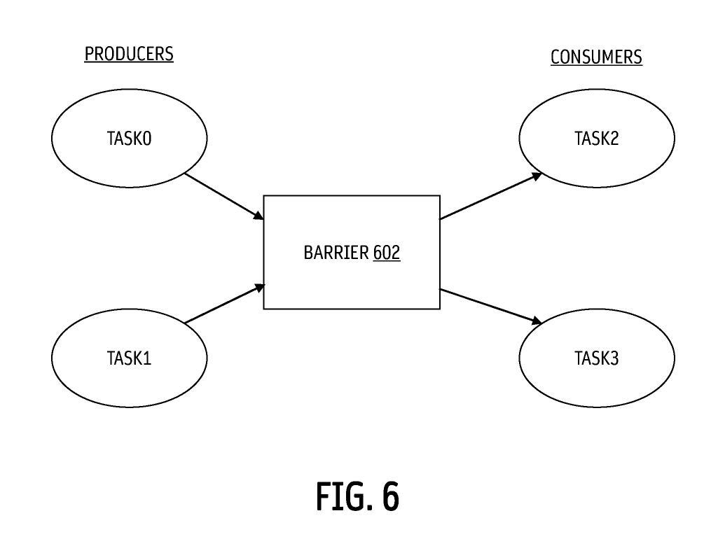

HW 220 includes memory 104, one or more instances of compute engine 140, and hardware barriers 280. Hardware barriers 280 can include synchronization primitives that coordinate execution and manage dependencies between tasks. DNN accelerator 102 has a limited number of hardware barriers 280 available on HW 220. An example of a hardware barrier is illustrated in FIG. 6.

Runtime SW/FW 210 can include logic for starting execution and managing execution. To start execution, runtime SW/FW 210 can perform one or more of: load binary 190, apply initial configuration, and initiate execution on DNN accelerator 102. To manage execution, runtime SW/FW 210 can perform one or more of: load task configuration descriptors to memory 104, launch tasks and push descriptors from memory 104 to a local memory/storage/buffer/registers of compute engine 140, manage synchronization by programming hardware barriers 280, and handle preemption events.

The compilation process illustrated in FIG. 2 shows that compiler 188 can generate a dynamic execution schedule, which requires runtime SW/FW 210 to monitor execution and perform management operations to ensure that the NN model can be executed correctly execute on HW 220. Many production DNN accelerator solutions rely on this kind of dynamic scheduling. Task submission to HW 220 and synchronization via hardware barriers 280 are handled at runtime, e.g., by runtime SW/FW 210. Runtime SW/FW 210 can monitor interrupts, reprogrammed barriers, and submit new tasks as execution progressed. While functional, this approach can introduce latency and resource contention, resulting in reduced NN performance.

Available NN compilers like IREE, XLA, OpenCL, Glow, TVM and others mostly do not touch low-level synchronization primitives such as hardware barriers 280 and leave this to backends specific to given HW architectures. Tools like OpenCL or low-level library/backends from HW vendors, even though they can provide application programming interfaces (APIs) for hardware barriers 280, those tools are mostly for handling at single kernel level and leave HW synchronization primitives reuse to runtime SW/FW 210, which means that that the generated binary 190 does not have a fully static schedule.

### Modifying the compiler process to generate a fully static schedule for a neural network model

Instead of following the approach illustrated in FIG. 2, an improved compiler can insert execution management operations into schedule to create fully static schedule that does not require significant assistance during execution from runtime SW/FW 210.

In various embodiments, the improved compiler can split a processing graph (representing a NN model) into subgraphs. Each subgraph can use a subset of available hardware barriers with multiple connection points to next subgraph. Careful assignment of virtual barriers to a subset of available hardware barriers when performing processing graph partitioning can ensure correct execution ordering and conflict-free reuse of HW barriers with low impact to original schedule layout. The proposed graph splitting/segmentation/partitioning method can simplify the mapping of synchronization points to hardware barriers and ensure safe reuse under hardware constraints. Moreover, the method is computationally efficient and not overly complex. Also, because neighboring subgraphs can have multiple connection points (e.g., multiple boundary task nodes), negative effects of partitioning schedule can be mitigated.

In various embodiments, the improved compiler may insert operations to reprogram barriers and submit tasks to hardware engines directly within the schedule, eliminating the need for runtime SW/FW involvement beyond an initial kick-start of execution to apply basic configuration and to trigger the first task. The compiler-generated schedule in the generated binary may include operations that reprogram barriers and submit workloads to hardware engines, which can remove the need for dynamic runtime management. Adding these operations and adding them correctly to the schedule can result in lower execution latency and more deterministic behavior.

The improved compiler can achieve several advantages. The improved compiler implements a computationally efficient method to generate a fully static schedule at compile-time. The improved compiler can enhance execution performance of DNN models by shifting the majority of dynamic scheduling responsibilities from runtime SW/FW to the compiler, overall execution efficiency can be increased.

FIG. 3 illustrates an improved computing system 300 with compiler 388 and DNN accelerator 302, according to some embodiments of the disclosure. Compiler 388 can implement the contributions described above.

Orchestration block 310 is inserted into the compilation process of compiler 388. Orchestration block 310 may include logic for orchestrating schedule with execution management operations. The logic can perform one or more of: perform schedule modifications, insert operations for loading task descriptors, insert operations for pushing tasks to HW, and insert operations for reprogramming barriers. In some embodiments, orchestration block 310 may be performed after middle-end 204 and before backend-end 206.

Binary 320 encapsulates instructions/configurations for the execution of a neural network model in hardware-specific format. Binary 320 can include one or more of: list of tasks, memory map, and scheduling and synchronization primitives. Binary 320 represents the final output, ready for deployment on the DNN accelerator 302. Binary 320 differs from binary 190 in that binary 320 has a fully static schedule, illustrated as schedule 340. Moreover, binary 320 differs from binary 190 in that binary 320 can include one or more of: operations for loading task descriptors, operations for pushing descriptors to HW, and operations for programming HW barriers. These operations have been inserted by orchestration block 310 block in compiler 388.

Runtime SW/FW 330 differs from runtime SW/FW 210 in that one or more active execution management operations are obviated: load task configuration (descriptors) to memory, launch tasks, push descriptors to HW, and manage synchronization (program barriers). Instead, those execution management operations are already embedded in binary 320, and would be performed out on DNN accelerator 302 simply by executing the tasks and operations in binary 320, all without active runtime management. Phrased differently, those execution management operations are carried out automatically as part of the scheduled tasks and instructions (e.g., part of schedule 340). As a result, runtime SW/FW 330 would only need to initiate execution, and binary 320 orchestrates those execution management operations internally. This approach eliminates the need for significant active runtime monitoring in runtime SW/FW 330 and enables fully deterministic execution of DNN models on DNN accelerator 302.

### Partitioning a processing graph into subgraphs and management operations insertion

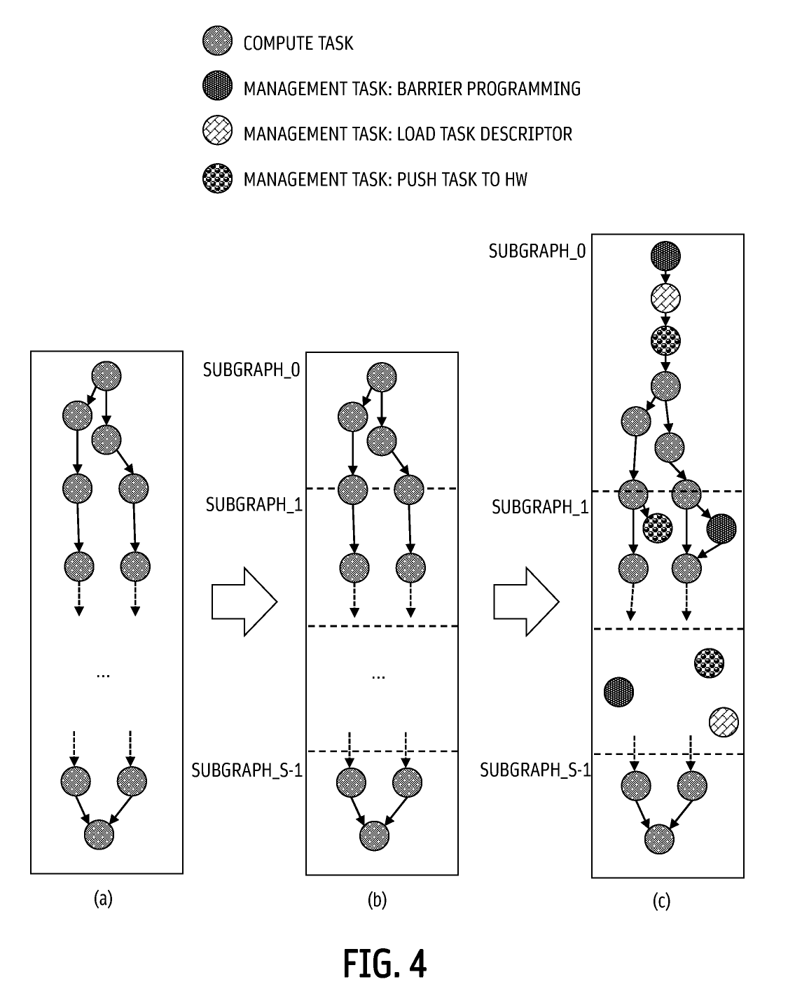

FIG. 4 illustrates multi-connectivity subgraph partitioning or segmentation, according to some embodiments of the disclosure. Specifically, a processing graph as shown is split into subgraphs and orchestrated with management operations. Part (a) shows an original processing graph. Part (b) shows the processing graph partitioned into subgraphs (e.g., subgraph_0, … subgraph_S-1). S is the number of subgraphs. Part (c) shows the processing graph with management task/operations inserted therein. FIG. 4 demonstrates the transformation of an initial processing graph into a set of subgraphs (e.g., from part (a) to part (b)), and the transformation of the partitioned subgraph where each subgraph is orchestrated with management operations to enable fully static scheduling and execution on hardware accelerators (e.g., from part (b) to part (c)).

Herein, a processing graph can represent a neural network model, in particular, the execution of the neural network model. A processing graph is a directed graph that represents the sequence and dependencies of computational tasks involved to execute a neural network model. A task node in the graph can correspond to an operation, task, or computation. An edge denotes a data or control dependency between tasks. The processing graph allows for systematic scheduling, optimization, and mapping of tasks onto hardware resources. In compiler and accelerator contexts, the processing graph serves as the foundation for partitioning, scheduling, and embedding management operations for efficient execution.

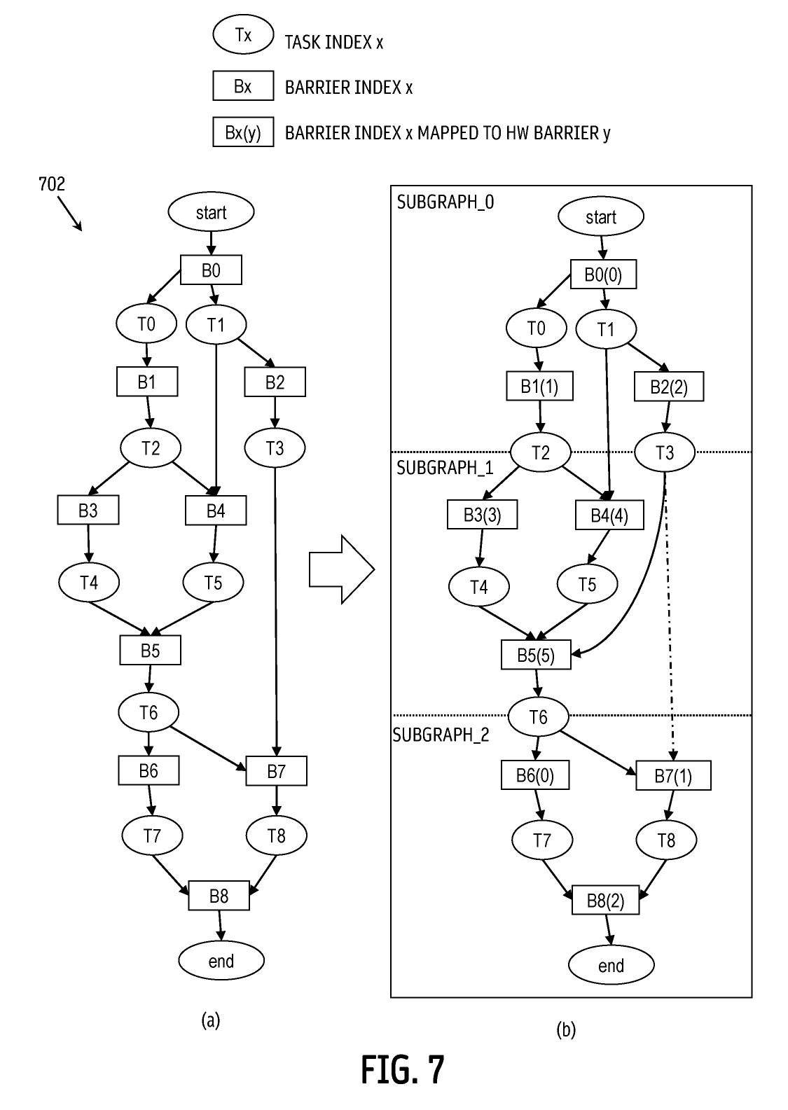

A processing graph is partitioned into subgraphs (e.g., illustrated by the transition between part (a) to (b)) such that only a subset of available hardware barriers is used within the subgraph, and consecutive subgraphs utilize disjoint sets of hardware barriers. This partitioning scheme enables safe and efficient reuse of limited hardware synchronization resources. The partitioning method allows for multiple connection points between subgraphs, preserving the natural structure of the computation graph and minimizing the negative impact of partitioning on parallelism and execution efficiency. Boundary tasks, which span multiple subgraphs, are legalized to ensure correct dependency semantics and safe barrier reuse. The partitioning process is further illustrated in FIG. 7.

Management tasks can be inserted (e.g., illustrated by the transition between part (b) to (c)) to enforce a fully static schedule. The resulting processing graph illustrated in part (c) can include one or more management task nodes, which represent one or more management tasks to facilitate execution management, synchronization, and hardware interaction. Management tasks for barrier programming can include operations that configure hardware barriers for synchronization between compute tasks. Management tasks for loading task descriptors can include operations that transfer task configuration data from a memory to a local memory accessible by the compute engines (e.g., compute engine 140 of FIG. 3). Management tasks for pushing tasks to hardware can include operations that initiate execution of compute tasks on hardware engines. In some embodiments, the compiler (e.g., compiler 388 of FIG. 3) may inject management operations into the schedule at compile-time, enabling fully static scheduling and eliminating the need for active runtime management. The resulting schedule comprises embedded management tasks that are executed automatically as part of the workload.

The improved compiler (e.g., compiler 388 of FIG. 3) can deliver advantages including improved execution performance, reduced runtime overhead, and deterministic behavior. By shifting execution management from runtime software or firmware to compile-time, hardware accelerators can operate at peak efficiency with minimal intervention.

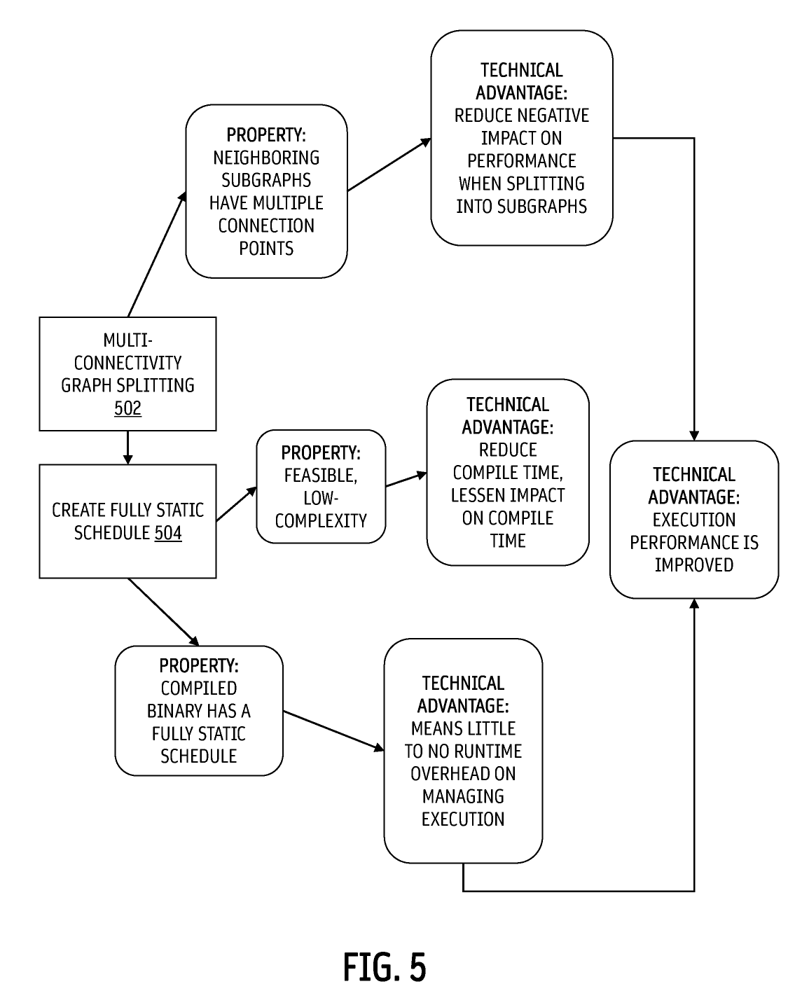

FIG. 5 illustrates properties and technical advantages of the approach involving multi-connectivity graph splitting 502 and creation of a fully static schedule 504, according to some embodiments of the disclosure.

Multi-connectivity graph splitting 502 has the property that neighboring subgraphs have multiple connection points. This property means that negative impact on performance when splitting into subgraphs is reduced.

Creation of a fully static schedule 504 has a property that the compiler implements a feasible, low-complexity algorithm. This property means that compile-time can be reduced or that the impact on compile-time can be lessened.

Creation of a fully static schedule 504 has a further property that the compiled binary has a fully static schedule. This property means that little to no run time overhead is needed to manage execution.

These technical advantages can lead to a dramatic improvement in execution performance of DNNs.

### Synchronization primitives: virtual barriers and hardware barriers

Before diving into processing graph partitioning, the following describes barriers, which are carefully taken into account in the compiler when creating a fully static schedule.

FIG. 6 illustrates barrier 602, according to some embodiments of the disclosure. Barrier 602 can be a virtual barrier to represent a synchronization point in the processing graph. A compiler can use virtual barriers as abstract synchronization points defined within the processing graph to manage dependencies and execution order between task nodes. A compiler can assign a unique, incrementing index to a virtual barrier. Barrier 602 can be a hardware barrier. A HW barrier is a HW based logic used for synchronization purposes. A HW barrier is a physical synchronization primitive provided and implemented in DNN accelerators. HW barriers can be used to signal task completion and coordinate the start of dependent tasks. Specifically, a HW barrier can receive information or signals from compute engines about their task completion and can notify the compute engines for next tasks to start executing. Example description or configuration of barrier 602 may include:
Barrier consumers - tasks released to execute once the barrier is signaled (e.g., TASK2 and TASK3)
Barrier producers - tasks that signal the barrier when complete (e.g., TASK0, and TASK1)

Barriers, e.g., barrier 602, may represent dependencies in part of schedule and after (e.g., once) related tasks have executed. Barrier 602 as a synchronization point can have one or more upstream tasks, or barrier producers. Each TASK0 and TASK0 may update barrier 602 and after (e.g., once) both have completed, barrier 602 may enable execution of one or more downstream tasks, or barrier consumers. Barrier 602 may release Task2 and Task3 so that Task2 and Task3 can start.

A HW barrier can be reprogrammed with new configuration for next part of schedule. In some implementations, runtime SW/FW of a DNN accelerator can manage assigning available HW barriers to virtual barriers in the processing graph (e.g., freeing up HW barriers when they are consumed and reprogramming the HW barriers). Runtime mapping of virtual barriers to HW barriers can create additional runtime overhead. To achieve static scheduling, a compiler can map virtual barriers to hardware barriers at compile-time. Mapping virtual barriers to HW barriers efficiently and in a conflict-free way at compile-time is not trivial.

### Task submissions onto DNN accelerators

Before diving into inserting management tasks into the processing graph, the following describes how tasks can be inserted into the processing graph to effectively perform a runtime management operation.

Task descriptors include the configuration and parameters used by compute engines (e.g., compute engine 140 of FIG. 3) to execute specific tasks. By having the compiler insert DMA operations or data movement operation into the execution graph, the process of copying these descriptors from memory to local memory/storage/registers/buffer of the compute engine becomes an explicit, scheduled part of execution. Phrased differently, the data movement operation copies task descriptors to compute engine registers. The compiler can insert the data movement operation to perform this copy, treating task submission as part of the execution graph.

By explicitly inserting the data movement task to move the task description onto the compute engine, task submission is no longer managed dynamically by runtime software or firmware. Instead, task submission is orchestrated at compile-time and embedded within the static schedule. The significance of this approach is that embedding the data movement tasks into the compiled binary eliminates runtime bottlenecks, reduces latency, and enables fully automated execution, allowing hardware accelerators to operate more efficiently and deterministically.

### Operating environment

Various embodiments described and illustrated herein may operate in an environment with one or more of the following properties:

The compiler prepares a static schedule (e.g., fully static schedule 504 of FIG. 5) from a processing graph of operations (e.g., representing a NN model). The processing graph can be generated by a compiler (e.g., compiler 388 of FIG. 3) after parsing a model definition (e.g., model definition 110 of FIG. 3).

The hardware (e.g., HW 220 of FIG. 3) provides synchronization primitives (physical barriers or hardware barriers 280 of FIG. 3). There is a limited number of synchronization primitives available on a given DNN accelerator (e.g., DNN accelerator 302).

A barrier (e.g., hardware barriers 280 of FIG. 3) can be reprogrammed to have a new configuration once tasks depending on the current configuration of a given barrier complete.

Tasks are submitted for execution by the compute engines (e.g., compute engine 140 of FIG. 3) by copying task descriptors from off-chip memory (e.g., memory 104 of FIG. 3) into local memory/storage/registers/buffer on compute engines (e.g., compute engine 140 of FIG. 3) through data movement operations.

### Graph partitioning algorithm and mapping virtual barriers to HW barriers

One of the challenges in static scheduling is that reusing hardware barriers safely is not trivial. The expected tasks should interact with a given barrier. The barrier may be reprogrammed before it is reused by the next part of the schedule. One of the technical tasks for a compiler to create a static schedule is to find a mapping between barriers in the processing graph (virtual barriers) to HW (or physical) barriers.

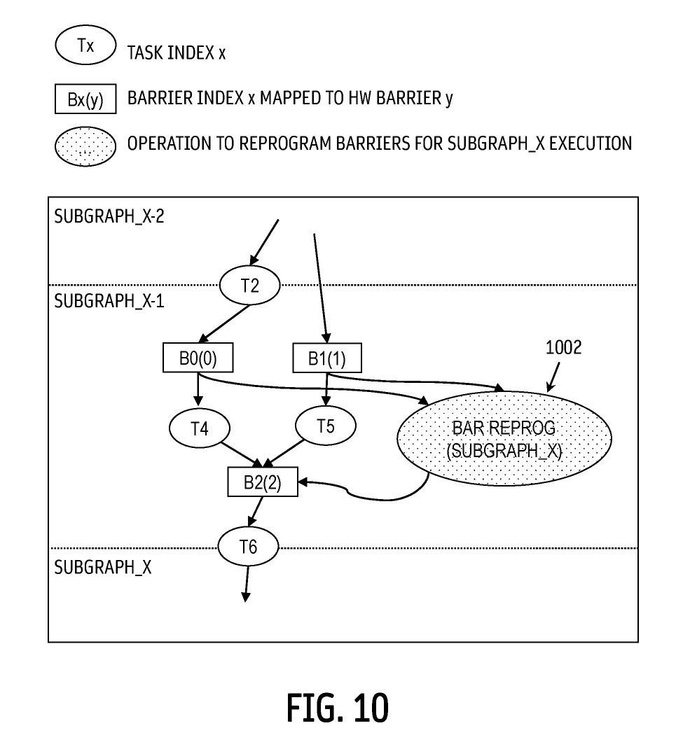

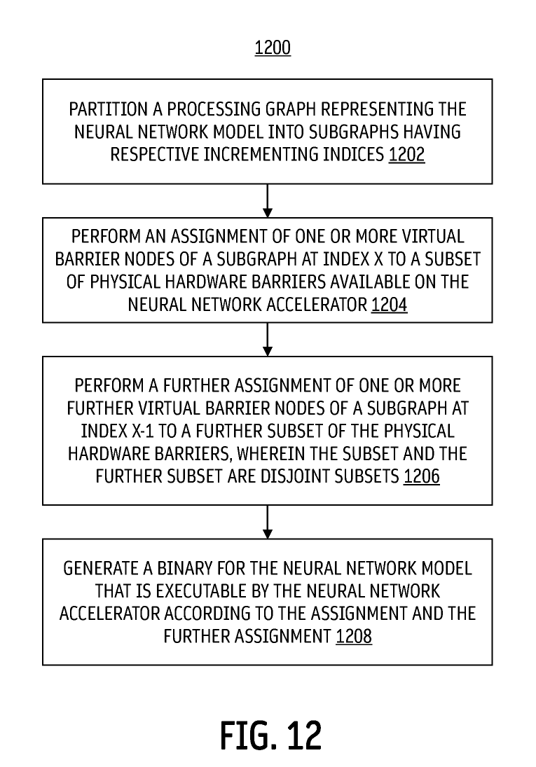

Building a performant fully static schedule can be expressed as a three-part process. Part one involves multi-connection point partitioning and schedule legalization (illustrated in FIGS. 7-9). Part two involves injecting barrier reconfiguration operations (illustrated in FIG. 10). Part three involves injecting task submission operations (e.g., FIG. 12).

FIG. 7 illustrates partitioning processing graph 702, according to some embodiments of the disclosure. Part (a) shows the original processing graph 702, and part (b) shows the result of applying a processing graph splitting/segmentation/partitioning method onto partitioning processing graph 702.

The processing graph splitting method offers a systematic and direct approach for achieving an efficient, compile-time mechanism to generate a fully static schedule. By partitioning the processing graph into distinct subgraphs, this method enables the compiler to assign hardware barriers to virtual barriers and insert management tasks in a manner that optimizes execution performance. Specifically, the approach reduces runtime overhead by ensuring all scheduling decisions are made during compilation, thereby streamlining the execution phase and improving overall system efficiency.

For any processing graph representing a schedule of operations, a compiler (e.g., compiler 388 of FIG. 3) may split the graph into subgraphs according to one or more of the following:
Each subgraph uses a subset of the total available HW barriers. For purposes of illustration, the DNN accelerator has N number of HW barriers available.
Consecutive subgraphs use disjoint sets of HW barriers meaning subgraph_X would use subset1 from N HW barriers and SubgraphX+1 would use subset2 from the N HW barriers.
Subgraphs that do not overlap in execution can reuse the same barrier subset.

The following outlines an implementation example:
N is the number of HW barriers available
Each subgraph uses half of the HW barriers. One subset of the HW barriers are in the range [0, N/2 – 1]. The other subset of the HW barriers is in the range [N/2, N-1]
   E.g., subgraph_1/3/5/7/<odd> use HW barriers from range [N/2, N-1]
   E.g., subgraph_0/2/4/6/<even> use HW barriers from range [0, N/2 - 1]
   Example where N= 6: subgraph_0/2/4/6/… use HW barriers 0, 1, and 2, and subgraph_1/3/5/7… use HW barriers 3, 4, and 5
Some tasks in subgraph_X can simultaneously use barriers from neighboring/adjacent subgraphs, e.g., some tasks in subgraph_X can use barriers from subgraph_X+1.
   No task in subgraph_X can use barriers from non-neighboring subgraphs, e.g., tasks in Subgraph_X cannot use barriers from SubgraphX+2 because subgraph_X uses same set of HW barriers as subgraph_X+2, which could lead to conflicts or incorrect synchronization.
   There can be multiple tasks using barriers from neighboring subgraphs. Such tasks are called boundary tasks, which operate across the boundaries of neighboring subgraphs and interact with barriers from both subgraphs.

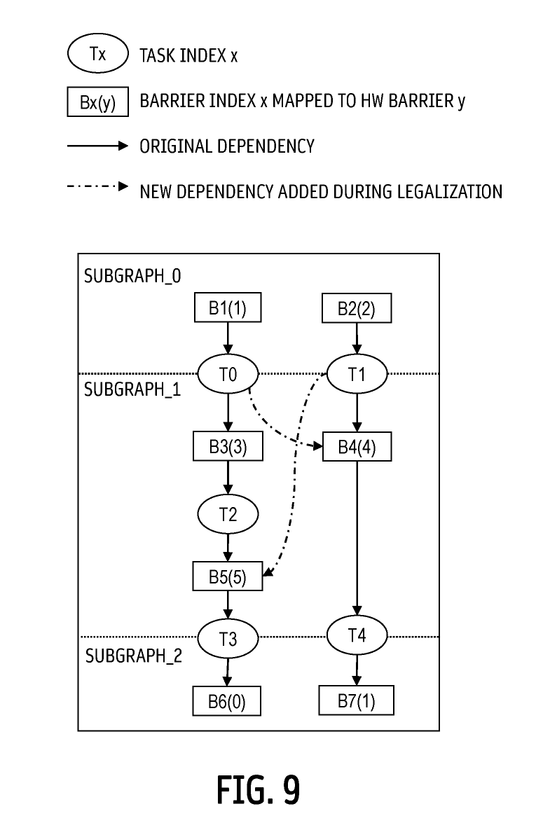

To align with subgraph split constraints graph partitioning process may perform one or more of the following operations:
1. Determine the number of available HW barriers.
   a. In FIG. 7, N=6.
2. Create disjoint subsets of HW barriers, e.g., N/2 barriers from range [0, N/2 - 1], and N/2 barriers from range [N/2, N-1], if two disjoint subsets are created.
   a. In FIG. 7, one subset of HW barriers have indices 0, 1, and 2. The other subset of HW barriers have indices 3, 4, and 5.
3. Traverse through the processing graph, assign virtual barriers to subgraphs according to their topological order.
   a. Virtual barrier at index “VirtBarInd” is assigned a subgraph index “subgraphIndex” based on number of HW barriers N: subgraphInd assigned to virtual barrier at index VirtBarInd is equal to floor(VirtBarInd / (N/2)).
   b. In FIG. 7, virtual barrier at index VirBarInd=2 is assigned to subgraph index subgraphInd = floor(2 / (6/2)) = 0. virtual barrier at index VirBarInd=5 is assigned to subgraph index subgraphInd = floor(5 / (6/2)) = 1. virtual barrier at index VirBarInd=8 is assigned to subgraph index subgraphInd = floor(8 / (6/2)) = 2.
   c. This means that each subgraph has a number of virtual barriers that is equal to half the number of HW barriers available (e.g., N/2).
   d. For example, subgraph_0 at index 0 has three virtual barriers assigned to HW barriers having indices 0, 1, and 2. Subgraph_1 at index 1 has three virtual barriers assigned to HW barriers having indices 3, 4, and 5. Subgraph_2 at index 2 has three virtual barriers assigned to HW barriers having indices 0, 1, and 2.
4. For each subgraph, assign virtual barriers to HW barriers.
   a. Virtual barrier at index VirtBarInd is assigned to HW barrier index “HwBarInd” based on the number of HW barriers N: HWBarInd is equal to VirtBarInd % N (% is the modulo operator).
   b. For example, virtual barrier at index VirBarInd=2 is assigned to HW barrier at HwBarInd = 2 % 6 = 2. Virtual barrier at index VirBarInd=5 is assigned to HW barrier at HwBarInd = 5 % 6 = 5. Virtual barrier at index VirBarInd=8 is assigned to HW barrier at HwBarInd = 8 % 6 = 2.
5. One or more boundary tasks, e.g., tasks which use barriers from more than one subgraph or two neighboring/adjacent subgraphs, can be identified. There can be multiple boundary tasks acting as synchronization points between subgraphs.
6. Identify and legalize tasks which use barriers from non-neighboring subgraphs. Check and legalize dependencies between boundary tasks. This process is further illustrated in FIG. 9.

In some embodiments, a compiler (e.g., compiler 388 of FIG. 3) can receive a processing graph having task nodes, virtual barrier nodes, and edges to connect nodes of the processing graph, such as the processing graph 702 as illustrated in part (a) of FIG. 7. The compiler can partition a processing graph (e.g., processing graph 702) representing the neural network model into subgraphs using one or more operations described and illustrated above and with FIG. 7. Subgraphs can have respective incrementing indices (e.g., subgraph_0, subgraph_1, … subgraph_X-1, subgraph_X, subgraph_X+1, subgraph_X+2 …), increasing from the start of the processing graph towards the end of the processing graph. Subgraphs can be associated with a sequence of indices. Once partitioned, the processing graph can have one or more boundaries separating subgraphs. Multi-connectivity between subgraphs is allowed. In some embodiments, at least one of the one or more boundaries separating subgraphs has two or more boundary task nodes. Having two or more boundary task nodes is not a strict requirement. For some processing graphs, the resulting boundaries may have just one boundary task node. For some processing graphs, such as processing graphs with a high amount of parallelism, the resulting boundaries may have two or more boundary task nodes.

The compiler can perform an assignment of one or more virtual barrier nodes of a subgraph at index X to a subset of physical hardware barriers available on the neural network accelerator. The compiler can also perform a further assignment of one or more further virtual barrier nodes of a subgraph at index X-1 to a further subset of the physical hardware barriers. The subset and the further subset are disjoint subsets. The compiler can generate a binary (e.g., binary 320 of FIG. 3) for the neural network model that is executable by the neural network accelerator according to the assignment and the further assignment.

In some embodiments, the compiler can further perform a yet further assignment of one or more yet further virtual barrier nodes of a subgraph at index X+1 to the further subset of the physical hardware barriers. Note that the same subset of physical hardware barriers are used for the virtual barrier nodes of the subgraph at index X+1 and the subgraph at index X-1.

The compiler can perform a first assignment of one or more virtual barrier nodes of a subgraph at index X to a first subset of physical hardware barriers available on the neural network accelerator. The compiler can also perform a second assignment of one or more further virtual barrier nodes of a subgraph at index X-1 to a second subset of the physical hardware barriers. The first subset and the second subset are disjoint subsets. The compiler can generate a binary (e.g., binary 320 of FIG. 3) for the neural network model that is executable by the neural network accelerator according to the first assignment and the second assignment.

In some embodiments, the compiler can further perform a third assignment of one or more yet further virtual barrier nodes of a subgraph at index X+1 to the second subset of the physical hardware barriers. Note that the same subset (i.e., the second subset) of physical hardware barriers are used for the virtual barrier nodes of the subgraph at index X+1 and the subgraph at index X-1. The subgraphs alternate or ping-pong between using the first subset and the second subset of hardware barriers.

When the compiler generates a binary representation of the neural network model according to the assignments, the compiler is generating the binary representation according to the processing graph. The hardware barrier assignments may not be explicitly encoded in the binary representation. In some cases, the hardware barrier assignments may be explicitly encoded in the binary representation to utilize a specific hardware barrier. In some cases, the hardware barrier assignments may be explicitly encoded in the binary representation to utilize a specific hardware barrier that has been reprogrammed according to the dependencies in the processing graph. In some cases, the hardware barrier assignments may be explicitly encoded in the binary representation to utilize an available hardware barrier. The effect of performing hardware barrier assignments using disjoint subsets for neighboring subgraphs is to ensure that the binary representation would be executed in a way that efficiently utilizes the hardware barriers (e.g., a limited resource) in a conflict-free way without runtime management of the hardware barriers.

In some embodiments, the compiler places a boundary separating the subgraph at index X and the further subgraph at index X-1 when the subgraph at index X has a number of virtual barriers is equal to a fraction of a number of the physical hardware barriers available on the neural network accelerator, e.g., a half of the physical hardware barriers available on the neural network accelerator. A fraction of the number of physical hardware barriers can be a half, a third, or a fourth. In some embodiments, the compiler places a boundary separating the subgraph at index X and the further subgraph at index X-1 when the subgraph at index X has a number of virtual barriers is equal to a number of the physical hardware barriers that are allocated for a subgraph. In some embodiments, the compiler places a boundary separating the subgraph at index X and the further subgraph at index X-1 when the subgraph at index X has a number of virtual barriers is equal to a threshold number of the physical hardware barriers. In other words, boundaries are placed such that a number of virtual barriers is equal to a fraction of a number of the physical hardware barriers available on the neural network accelerator is assigned to a subgraph.

This processing graph splitting process represents and illustrates a low-complexity way to map virtual barriers to HW barriers. The issue with complex algorithms to assign virtual barriers to HW barriers may not be visible on small graphs, but when the number of edges in the processing graph is much larger than HW barriers, difficulty can increase. It can be a non-trivial and complex task for a compiler to find what barrier in schedule can safely use given HW barrier, especially when the processing graph is executed on system with high parallelism (e.g., tasks can execute on multiple engines, and they need to be synchronized). Therefore, the technique described and illustrated herein for processing graph partitioning can make creating a fully static schedule at compile-time feasible to implement.

### Legalization of long dependencies when partitioning the processing graph into subgraphs

In cases where tasks use barriers from non-neighboring subgraphs, e.g., subgraph_X and subgraph_X+i, where i>1, long dependencies stretching over non-neighboring subgraphs may be rerouted or edited through an intermediate task or one of synchronization points. Rerouting the long dependency can preserve the dependency semantics while ensuring the modified edge follows legal barrier usage constraints defined by the subgraph partitioning method. This redirection can prevent conflicts caused by shared barrier sets across non-adjacent subgraphs. The redirection can avoid illegal or conflicting barrier reuse while still maintaining correct execution semantics. In the original processing graph 702 in part (a) of FIG. 7, Task T3 may be directly connected to Barrier B7, which enables Task T8. However, this would violate subgraph isolation since B7 does not belong to the correct barrier subset, since subgraph_0 and subgraph_2 use same HW barriers. The compiler instead rewrites the dependency. T3 signals Barrier B5, enabling Task T6. T6 then signals Barrier B7, which in turn enables T8 through Barrier B8. The rerouting of the edge between T7 and B7 to T7 to B5 can preserve the execution order while satisfying subgraph split constraints and ensuring safe barrier reuse.

### Performance impact of allowing multiple connections between subgraphs

The multiple connections between subgraphs (e.g., the multiple boundary tasks separating two adjacent/neighboring subgraphs) enables more of the original structure of processing graph 702 on subgraph boundary. In FIG. 7, two boundary tasks, Task T2 and Task T3 separates subgraph_0 and subgraph_1. Allowing multiple connections is beneficial from performance perspective compared to single synchronization point, which can cause synchronization of all parallel execution branches to be dependent on a single barrier or single task.

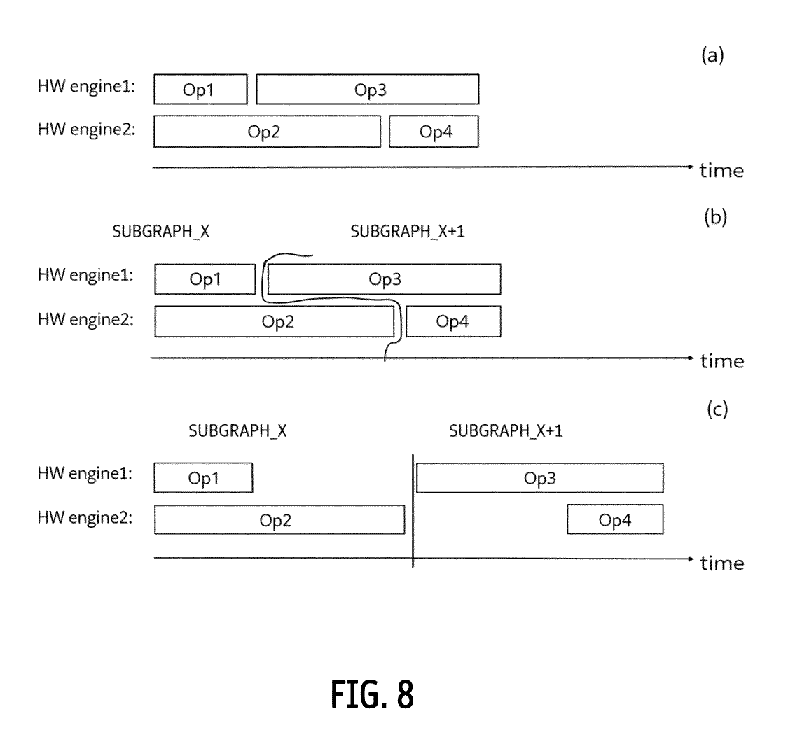

FIG. 8 illustrates compares execution traces with or without allowing multiple boundary tasks between subgraphs, according to some embodiments of the disclosure. Part (a) illustrates an original execution operation trace without partitioning the processing graph into subgraphs. Part (b) illustrates an execution operation trace with partitioning where multiple connections separating subgraphs is allowed (e.g., the processing graph is split where multiple boundary tasks can be present at a boundary separating two neighboring subgraphs). Part (c) illustrates an execution trace with partitioning where multiple connections separating subgraphs is not allowed (e.g., the processing graph is split using a single synchronization point). It can be seen that allowing multiple connections can allow more of the original execution to be preserved across parallel execution branches on HW engine1 and HW engine2. In contrast, disallowing multiple connections and requiring a single synchronization point can extend execution time of parallel execution branches on HW engine1 and HW engine2.

### Legalization of boundary tasks when partitioning the processing graph into subgraphs

After identifying boundary tasks, their dependencies may need to be legalized to guarantee that any first task waiting at barrier from subgraph_X and producing into barrier from subgraph_X+1 is guaranteed to start after all barriers from subgraph_X-1 are used. Phrased differently, the process guarantees that any task in subgraph_X, which waits on a barrier and produces output for a barrier in subgraph_X+1, will only begin execution after all barriers from subgraph_X-1 have been fully utilized. The legalization procedure to edit one or more edges/dependencies may be applied to ensure correct execution order and barrier usage, since subgraphX+1 and subgraphX-1 use same set of HW barriers.

FIG. 9 illustrates legalization of one or more boundary task nodes, according to some embodiments of the disclosure. The legalization procedure of boundary task nodes involves editing one or more edges or dependencies in the processing graph. By modifying these connections, the compiler ensures that the execution order respects the constraints imposed by the partitioning process and shared hardware barriers. Legalization can be used to maintain both the isolation of subgraphs and the correct semantics of barrier usage, particularly in systems with high degrees of parallelism.

The boundary task legalization procedure can include one or more of the following operations:
1. Identify all boundary tasks between neighboring subgraphs, subgraph_X-1 and subgraph_X. Store the boundary task(s) in Boundary Task Set 1.
2. Identify all boundary tasks between neighboring subgraphs, subgraph_X and subgraph_X+1. Store the boundary task(s) in Boundary Task Set 2.
3. Check whether each task in Boundary Task Set 2 depends on all tasks from Boundary Task Set 1. This check can determine whether there are parallel execution paths in subgraph_X that do not depend on each other.
   a. When there is a task in Boundary Task Set 2 that does not depend on all tasks from Boundary Task Set 1, create a dependency or edge through one or more barriers in subgraph_X. a. When there is a task in Boundary Task Set 2 that does not depend on all tasks from Boundary Task Set 1, create a dependency or edge through one or more barriers in subgraph_X.

As shown in FIG. 9, Task T0 and Task T1 are on a boundary separating subgraph_0 and subgraph_1, which forms Boundary Task Set 1. Task T3 and Task T4 are on boundary separating subgraph_1 and subgraph_2, which forms Boundary Task Set 2. The legalization procedure checks if each task in Boundary Task Set 2 (T3 and T4) depends on all tasks from Boundary Task Set 1 (T1 and T2). The procedure identifies that there is no dependency in original schedule between T0 and T4 and there is no dependency in original schedule between T1 and T3. The lack of dependency for each task in Boundary Task Set 2 on all tasks from Boundary Task Set 1 presents a problem because if T4 starts early and interacts with Barrier B7 assigned to HW barrier with index 1 in subgraph_2 before Barrier B1 assigned to the same HW barrier with index 1 is consumed, then a conflict can occur. Accordingly, the legalization procedure creates a new dependency using one or more barriers in subgraph_1. Barrier B5 now depend on Task T1 and Barrier B4 now depend on Task T0 to ensure that Task T3 and Task T4 producing into subgraph_2 do not start before all barriers in subgraph_0 (e.g., B1(1) and B2(1)) are consumed. With the legalization procedure, no matter what is the timing between parallel branches of execution, all barriers from subgraph_0 can be consumed before any task producing into barrier(s) from subgraph_2 starts.

In some embodiments, the compiler (e.g., compiler 388 of FIG. 3) can identify one or more boundary task nodes separating the subgraph at index X-1 and the subgraph at index X (the one or more boundary task nodes form Boundary Task Set 1). The compiler can identify one or more further boundary task nodes separating the subgraph at index X and a subgraph at index X+1 (the one or more further boundary task nodes form Boundary Task Set 1). The compiler can determine that a further boundary task node of the one or more further boundary task nodes does not depend on at least one of the one or more boundary tasks nodes. For example, the compiler determines that T3 does not depend on T1 in the processing graph illustrated in FIG. 9. This determination indicates there are parallel execution paths that do not depend on each other in the subgraph at index X. The compiler can add a dependency between the further boundary task node of the one or more further boundary task nodes and the boundary task node of the one or more boundary tasks nodes. Adding the dependency can ensure there is a timing dependency between the parallel execution paths.

In some embodiments, the compiler can add the dependency by adding an edge to connect the boundary task node of the one or more boundary tasks nodes to a hardware barrier node in the subgraph at index X that is immediately upstream of the further boundary task node of the one or more further boundary task nodes. As seen in FIG. 9, the dependency for Task T1 is added to barrier B5 (which is immediately upstream of T3) instead of to B3, when the dependency is added to ensure that T3 depends on both T0 and T1. By connecting the boundary task node to a hardware barrier node in the subgraph at index X that is immediately upstream of the further boundary task node, the compiler ensures that the new dependency is enforced as late as possible in the execution sequence. This approach allows most parallel tasks in the downstream subgraph to proceed without unnecessary delays, only synchronizing at the last possible moment before the next set of tasks begins. As a result, the system maintains high parallelism and avoids introducing broad synchronization points that could slow down execution. In plain terms, this technique helps keep the system running efficiently by only pausing tasks when absolutely necessary, rather than causing widespread waiting across the computation graph.

### Inject barrier reconfiguration operations

Hardware barriers may be configurable and may be programmed before they are used. Each configuration of a HW barrier may define which tasks produce and consume a given barrier. Since barriers may be limited and shared across subgraph, they may be reconfigured dynamically to fit each subgraph’s synchronization needs. The compiler can ensure HW barriers are reconfigured appropriately and correctly by injecting dedicated barrier configuration operations into the schedule (e.g., by adding DMA transaction task into the processing graph at a suitable location). These reconfiguration operations may be treated like normal tasks and executed on hardware.

The reconfiguration operations may be added according to one or more of the following:
Reprogramming for HW barriers of subgraph_X can begin after all uses of the same hardware barriers in earlier subgraphs (e.g., subgraph_X-2) are completed.
Reprogramming for HW barriers of subgraph_X is finished before any task in subgraph_X starts using those HW barriers.

This careful placement can ensure that HW barriers are reconfigured at the right time, without requiring intervention from runtime SW/FW (e.g., runtime SW/FW 330 of FIG. 3), and avoid any overlap or misuse.

The following illustrates an example where HW barriers split in half into two subsets of HW barriers assigned to neighboring subgraphs:
Subgraph_X-2 and subgraph_X use the same half of HW barriers (e.g., HW barriers from range [0, N/2 - 1]).
Subgraph_X+1 uses second half of HW barriers (e.g., HW barriers from range [N/2, N -1]).
Programming for HW barriers in subgraph_X happens within subgraph_X-1.

FIG. 10 illustrates adding barrier reprogramming task node 1002 to subgraph_X-1, according to some embodiments of the disclosure. Specifically, FIG. 10 illustrates a barrier programming operation that configures HW barriers for subgraph_X (represented by barrier reprogramming task node 1002) executing within subgraph_X-1 after all tasks from subgraph_X-2 have completed. Barrier reprogramming task node 1002 is inserted downstream of Barrier B0 and Barrier B1 (tasks of subgraph_X-2 are producers into B0 and B1, and barrier reprogramming task node 1002 is a consumer of B0 and B1) to ensure that the barrier reprogramming operation is performed when all uses of barriers in subgraph_X-2 are guaranteed to be completed. Barrier reprogramming task node 1002 is inserted upstream of Barrier B2 (first task T6 of subgraph_X will not start until the operation is completed) to ensure that the operation is performed before any task in subgraph_X begins using the HW Barriers for subgraph_X.

In some embodiments where the DNN accelerator (e.g., HW 220 of FIG. 3) has a first-in-first-out (FIFO) buffer for barrier configurations, a single programing task can configure multiple instances of the HW barrier. With FIFO buffer support, the barrier programming operation does not need to be placed in each subgraph, but when all the instances have been consumed throughout the schedule.

For example, HW barrier 0 can accept four instances/sets of physical barrier configurations:
Subgraph_X+6: VirtualBarrierD mapped to HW barrier 0
Subgraph_X: VirtualBarrierA mapped to HW barrier 0
Subgraph_X+4: VirtualBarrierC mapped to HW barrier 0
Subgraph_X+2: VirtualBarrierB mapped to HW barrier 0

With FIFO buffer support, the barrier programming operation for this HW barrier 0 can be inserted in subgraph_X-1 to program all four instances, VirtualBarrierA-D, as a single barrier reprogramming operation. A further barrier programming operation for this HW barrier 0 can be inserted in subgraph_X+7 to program four further instances (for subgraph_X+8, subgraph_X+10, subgraph_X+12, and subgraph_X+14).

In some embodiments, the compiler (e.g., compiler 388 of FIG. 3) can add a barrier reprogramming task node (e.g., barrier reprogramming task node 1002) in the subgraph at index X-1. The barrier reprogramming task node can reprogram the subset of physical barriers used in the subgraph at index X.

In some embodiments, the barrier reprogramming task node (e.g., barrier reprogramming task node 1002) is added downstream of one or more virtual barrier nodes in the subgraph at index X-1 that synchronizes completion of one or more task nodes in a subgraph at index X-2.

In some embodiments, the barrier reprogramming task node (e.g., barrier reprogramming task node 1002) is added upstream of one or more virtual barrier nodes in the subgraph at index X that synchronizes completion of one or more task nodes in the subgraph at index X.

### Inject task submission operation

To execute or submit a task onto the compute engines (e.g., compute engine 140 of FIG. 3), the configuration (e.g., task descriptor) of the task may be copied from memory (e.g., memory 104 of FIG. 3) into the compute engine's registers or local memory. The copying of the configuration can be performed using a data movement engine that can move data between the memory and the compute engine’s registers or local memory. In DNN accelerators with runtime SW/FW management, this submission may be handled dynamically, meaning a management layer may wait for the right time, then push the task descriptor when all preconditions (e.g., barrier releases) are met. Runtime management of task submissions can consume significant runtime resources.

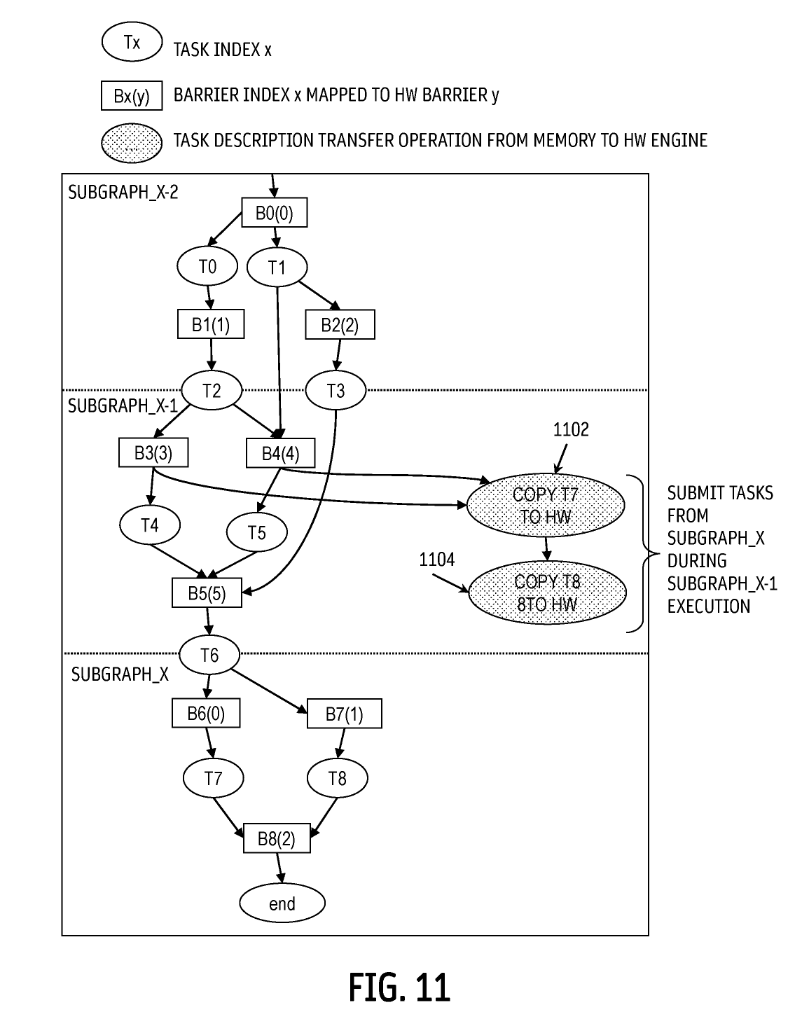

FIG. 11 illustrates adding one or more data movement task nodes (e.g., data movement task node 1102 and data movement task node 1104) to a subgraph (e.g., subgraph_X-1), according to some embodiments of the disclosure. In a fully static schedule, task submission cannot rely on runtime assistance. Instead, the compiler may insert task submission operations directly into the schedule. Exception may be first task in the schedule which needs to be started by runtime as part of bootstrap initialization to begin execution of whole schedule.

These task submission operations may take the form of DMA transfers or data movement transfer tasks, where the source is the memory location of the task descriptor and the destination is the appropriate compute engine's configuration registers. Since task execution cannot begin until its descriptor has been submitted, these operations may be timed correctly within the schedule. A possible approach is to place the task submission operations for tasks in subgraph_X into subgraph_X-1.

In the graph split illustrated in FIG. 11, tasks that start executing at subgraph_X, e.g., Task T7 and Task T8, may have their task configurations copied from memory to registers earlier in subgraph_X-1 to hide latency of memory transfer. Specifically, data movement task node 1102 to submit the Task T7 (i.e., to copy the task descriptor for T7 to the compute engine’s configuration registers) and data movement task node 1104 (i.e., to copy the task descriptor for T8 to the compute engine’s configuration registers) are inserted downstream of Barrier B3 and Barrier B4. During execution of subgraph_X-1, Barrier B3 and Barrier B4 can trigger the data movement transfer tasks to effectively submit T7 and T8 to the compute engine.

In some embodiments, task descriptors can be represented as a linked list of operations. Submitting multiple tasks (e.g., pushing the tasks descriptors of multiple tasks) can be performed by submitting or pushing just a list head descriptor that points to other task descriptors in the linked list.

In some embodiments, the compiler can add a data movement task node in the subgraph at index X-1 (e.g., ubgraph_X-1). Examples of the data movement task node includes data movement task node 1102 and data movement task node 1104. The data movement task node is to move one or more task descriptors associated with one or more task nodes in the subgraph at index X (e.g., subgraph_X) from a memory (e.g., memory 104 of FIG. 3) to a further memory of the neural network accelerator (e.g., configuration registers of compute engine 140 of FIG. 3).

In some embodiments, the data movement task node is added downstream of one or more virtual barrier nodes in the subgraph at index X-1 (e.g., B3 and B4 in subgraph_X-1) that synchronizes completion of one or more task nodes in a subgraph at index X-2 (e.g., tasks in subgraph_X-2).

### Exemplary method for compiling a neural network model

FIG. 12 is a flow diagram illustrating method 1200 for compiling a neural network model to be executed on a neural network accelerator, according to some embodiments of the disclosure. Method 1200 can be executed by compiler 388 of FIG. 3.

In 1202, a compiler can partition a processing graph representing the neural network model into subgraphs having respective incrementing indices. The processing graph can include task nodes, virtual barrier nodes, edges to connect nodes of the processing graphs, and one or more boundaries separating subgraphs, and at least one of the one or more boundaries separating subgraphs has two or more boundary task nodes.

In 1204, the compiler can perform an assignment of one or more virtual barrier nodes of a subgraph at index X to a subset of physical hardware barriers available on the neural network accelerator.

In 1206, the compiler can perform a further assignment of one or more further virtual barrier nodes of a subgraph at index X-1 to a further subset of the physical hardware barriers, wherein the subset and the further subset are disjoint subsets.

In 1208, the compiler can generate a binary for the neural network model that is executable by the neural network accelerator according to the assignment and the further assignment.

### Exemplary computing device

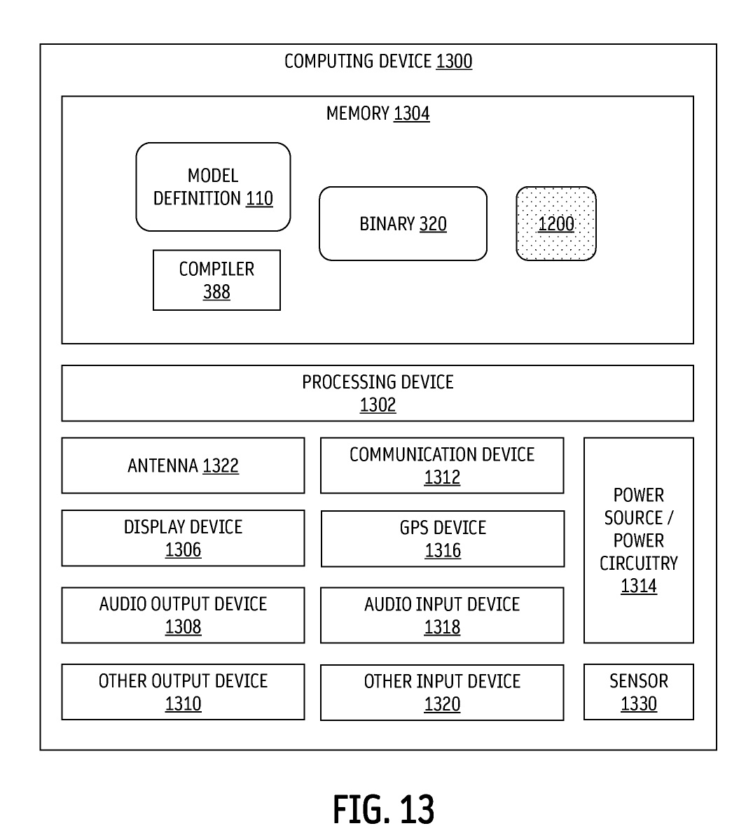

FIG. 13 is a block diagram of an apparatus or a system, e.g., an exemplary computing device 1300, according to some embodiments of the disclosure. One or more computing devices 1300 may be used to implement the functionalities described with the FIGS. and herein. A number of components illustrated in FIG. 13 can be included in the computing device 1300, but any one or more of these components may be omitted or duplicated, as suitable for the application. In some embodiments, some or all of the components included in the computing device 1300 may be attached to one or more motherboards. In some embodiments, some or all of these components are fabricated onto a single system on a chip (SoC) die. Additionally, in various embodiments, the computing device 1300 may not include one or more of the components illustrated in FIG. 13, and the computing device 1300 may include interface circuitry for coupling to the one or more components. For example, the computing device 1300 may not include a display device 1306, and may include display device interface circuitry (e.g., a connector and driver circuitry) to which a display device 1306 may be coupled. In another set of examples, the computing device 1300 may not include an audio input device 1318 or an audio output device 1308 and may include audio input or output device interface circuitry (e.g., connectors and supporting circuitry) to which an audio input device 1318 or audio output device 1308 may be coupled.

Computing device 1300 may include a processing device 1302 (e.g., one or more processing devices, one or more of the same types of processing device, one or more of different types of processing device). Processing device 1302 may include electronic circuitry that processes electronic data from data storage elements (e.g., registers, memory, resistors, capacitors, quantum bit cells) to transform that electronic data into other electronic data that may be stored in registers and/or memory. Examples of processing device 1302 may include a CPU, a GPU, a quantum processor, a machine learning processor, an artificial intelligence processor, a neural network processor, an artificial intelligence accelerator, an ASIC, an analog signal processor, an analog computer, a microprocessor, a digital signal processor, a field programmable gate array (FPGA), a tensor processing unit (TPU), a neural network hardware accelerator, a DNN hardware accelerator (e.g., having DNN accelerator 102 or DNN accelerator 302 as illustrated in FIGS. 1-3 and as described herein), etc. Processing device 1302 may have synchronization primitives/resources such as hardware barriers for synchronization operations being executed on the processing device 1302.

Computing device 1300 may include a memory 1304, which may itself include one or more memory devices such as volatile memory (e.g., DRAM), non-volatile memory (e.g., read-only memory (ROM)), high-bandwidth memory (HBM), flash memory, solid state memory, and/or a hard drive. Memory 1304 includes one or more non-transitory computer-readable storage media. In some embodiments, memory 1304 may include memory that shares a die with the processing device 1302.

In some embodiments, memory 1304 includes one or more non-transitory computer-readable media storing instructions executable to perform operations described with the FIGS. and herein. Memory 1304 may include one or more non-transitory computer-readable media storing instructions executable to perform one or more operations described with method 1200 of FIG. 2. Exemplary parts, e.g., compiler 388, that may be encoded as instructions and stored in memory 1304 are depicted. The instructions stored in the one or more non-transitory computer-readable media may be executed by processing device 1302. In some embodiments, memory 1304 may store instructions executable to perform one or more operations associated with compiler 388 and runtime SW/FW 330.

In some embodiments, memory 1304 may store data, e.g., data structures, binary data, bits, metadata, files, blobs, etc., as described with the FIGS. and herein. Memory 1304 may store inputs, intermediate inputs, intermediate outputs, and outputs the process illustrated in FIGS. 2-5, 7, and 9-11, and method 1200 of FIG. 12. Memory 1304 may store one or more of: model definition 110, and binary 320.

In some embodiments, memory 1304 may store one or more DNNs (and or parts thereof). Memory 1304 may store training data for training (trained) a DNN. Memory 1304 may store instructions that perform operations associated with training a DNN. Memory 1304 may store input data, output data, intermediate outputs, intermediate inputs of one or more DNNs. Memory 1304 may store one or more parameters used by the one or more DNNs. Memory 1304 may store information that encodes how nodes of the one or more DNNs are connected with each other. Memory 1304 may store instructions to perform one or more operations of the one or more DNNs. Memory 1304 may store a model definition that specifies one or more operations of a DNN. Memory 1304 may store instructions, such as binary 190, that are generated by compiler 188 based on the model definition.

In some embodiments, computing device 1300 may include a communication device 1312 (e.g., one or more communication devices). For example, communication device 1312 may be configured for managing wired and/or wireless communications for the transfer of data to and from the computing device 1300. The term "wireless" and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1312 may implement any of a number of wireless standards or protocols, including but not limited to Institute for Electrical and Electronic Engineers (IEEE) standards including Wi-Fi (IEEE 1302.10 family), IEEE 1302.16 standards (e.g., IEEE 1302.16-2005 Amendment), Long-Term Evolution (LTE) project along with any amendments, updates, and/or revisions (e.g., advanced LTE project, ultramobile broadband (UMB) project (also referred to as "3GPP2"), etc.). IEEE 1302.16 compatible Broadband Wireless Access (BWA) networks are generally referred to as WiMAX networks, an acronym that stands for worldwide interoperability for microwave access, which is a certification mark for products that pass conformity and interoperability tests for the IEEE 1302.16 standards. The communication device 1312 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1312 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1312 may operate in accordance with other wireless protocols in other embodiments. Computing device 1300 may include an antenna 1322 to facilitate wireless communications and/or to receive other wireless communications (such as radio frequency transmissions). Computing device 1300 may include receiver circuits and/or transmitter circuits. In some embodiments, communication device 1312 may manage wired communications, such as electrical, optical, or any other suitable communication protocols (e.g., the Ethernet). As noted above, communication device 1312 may include multiple communication chips. For instance, a first communication device 1312 may be dedicated to shorter-range wireless communications such as Wi-Fi or Bluetooth, and a second communication device 1312 may be dedicated to longer-range wireless communications such as global positioning system (GPS), EDGE, GPRS, CDMA, WiMAX, LTE, EV-DO, or others. In some embodiments, a first communication device 1312 may be dedicated to wireless communications, and a second communication device 1312 may be dedicated to wired communications.

Computing device 1300 may include power source / power circuitry 1314. The power source / power circuitry 1314 may include one or more energy storage devices (e.g., batteries or capacitors) and/or circuitry for coupling components of the computing device 1300 to an energy source separate from the computing device 1300 (e.g., DC power, AC power, etc.).

Computing device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

Computing device 1300 may include an audio output device 1308 (or corresponding interface circuitry, as discussed above). The audio output device 1308 may include any device that generates an audible indicator, such as speakers, headsets, or earbuds, for example.

Computing device 1300 may include an audio input device 1318 (or corresponding interface circuitry, as discussed above). The audio input device 1318 may include any device that generates a signal representative of a sound, such as microphones, microphone arrays, or digital instruments (e.g., instruments having a musical instrument digital interface (MIDI) output).

Computing device 1300 may include a GPS device 1316 (or corresponding interface circuitry, as discussed above). The GPS device 1316 may be in communication with a satellite-based system and may receive a location of the computing device 1300, as known in the art.

Computing device 1300 may include a sensor 1330 (or one or more sensors). Computing device 1300 may include corresponding interface circuitry, as discussed above). Sensor 1330 may sense physical phenomenon and translate the physical phenomenon into electrical signals that can be processed by, e.g., processing device 1302. Examples of sensor 1330 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 1300 may include another output device 1310 (or corresponding interface circuitry, as discussed above). Examples of the other output device 1310 may include an audio codec, a video codec, a printer, a wired or wireless transmitter for providing information to other devices, haptic output device, gas output device, vibrational output device, lighting output device, home automation controller, or an additional storage device.

Computing device 1300 may include another input device 1320 (or corresponding interface circuitry, as discussed above). Examples of the other input device 1320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 1300 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1300 may be any other electronic device that processes data.

### Select examples

Example 1 provides an apparatus for compiling a neural network model to be executed on a neural network accelerator, including a processor; and a memory to store instructions, that when executed by the processor, cause the processor to: partition a processing graph representing the neural network model into one or more subgraphs, the one or more subgraphs being associated with a sequence of indices, where the processing graph has one or more task nodes and one or more virtual barrier nodes; perform a first assignment of one or more virtual barrier nodes of a subgraph at index X to a first subset of hardware barriers of the neural network accelerator; perform a second assignment of one or more further virtual barrier nodes of a subgraph at index X-1 to a second subset of the hardware barriers, where the first subset and the second subset are disjoint subsets; and generate a binary representation of the neural network model that is executable by the neural network accelerator according to the first assignment and the second assignment.

Example 2 provides the apparatus of example 1, where the instructions further cause the processor to: perform a third assignment of one or more yet further virtual barrier nodes of a subgraph at index X+1 to the second subset of the hardware barriers.

Example 3 provides the apparatus of example 1 or 2, where the processor partitions the processing graph into subgraphs by: placing a boundary separating the subgraph at index X and the subgraph at index X-1 when the subgraph at index X has a number of virtual barriers that is equal to a threshold number of the hardware barriers on the neural network accelerator.

Example 4 provides the apparatus of any one of examples 1-3, where the instructions further cause the processor to: identify a first boundary task nodes separating the subgraph at index X-1 and the subgraph at index X; identify a second boundary task nodes separating the subgraph at index X and a subgraph at index X+1; determine that the second boundary task node does not depend on the first boundary task node; and add a dependency between the second boundary task node and the first boundary task node.

Example 5 provides the apparatus of example 4, where the processor adds the dependency by adding an edge to connect the first boundary task node to a virtual barrier node in the subgraph at index X that is immediately upstream of the second boundary task node.

Example 6 provides the apparatus of any one of examples 1-5, where the instructions further cause the processor to: add a barrier reprogramming task node in the subgraph at index X-1, the barrier reprogramming task node to reprogram the first subset of the hardware barriers used in the subgraph at index X.

Example 7 provides the apparatus of example 6, where the barrier reprogramming task node is added downstream of one or more virtual barrier nodes in the subgraph at index X-1 that synchronizes completion of one or more task nodes in a subgraph at index X-2.

Example 8 provides the apparatus of example 6 or 7, where the barrier reprogramming task node is added upstream of one or more virtual barrier nodes in the subgraph at index X that synchronizes completion of one or more task nodes in the subgraph at index X.

Example 9 provides the apparatus of any one of examples 1-8, where the instructions further cause the processor to: add a data movement task node in the subgraph at index X-1, the data movement task node to move one or more task descriptors associated with one or more task nodes in the subgraph at index X from a memory to a further memory of the neural network accelerator.

Example 10 provides the apparatus of example 9, where the data movement task node is added downstream of one or more virtual barrier nodes in the subgraph at index X-1 that synchronizes completion of one or more task nodes in a subgraph at index X-2.

Example 11 provides the apparatus of any one of examples 1-10, where the processing graph further includes one or more boundaries separating subgraphs and at least one of the one or more boundaries has two or more boundary task nodes.

Example 12 provides one or more non-transitory computer-readable media storing instructions for compiling a neural network model to be executed on a neural network accelerator, that when executed by a processor, cause the processor to: partition a processing graph representing the neural network model into one or more subgraphs, the one or more subgraphs being associated with a sequence of indices, where the processing graph has one or more task nodes and one or more virtual barrier nodes; perform a first assignment of one or more virtual barrier nodes of a subgraph at index X to a first subset of hardware barriers of the neural network accelerator; perform a second assignment of one or more further virtual barrier nodes of a subgraph at index X-1 to a second subset of the hardware barriers, where the first subset and the second subset are disjoint subsets; and generate a binary representation of the neural network model that is executable by the neural network accelerator according to the first assignment and the second assignment.

Example 13 provides the one or more non-transitory computer-readable media of example 12, where the instructions further cause the processor to: perform a third assignment of one or more yet further virtual barrier nodes of a subgraph at index X+1 to the second subset of the hardware barriers.

Example 14 provides the one or more non-transitory computer-readable media of example 12 or 13, where the processor partitions the processing graph into subgraphs by: placing a boundary separating the subgraph at index X and the subgraph at index X-1 when the subgraph at index X has a number of virtual barriers that is equal to a threshold number of the hardware barriers on the neural network accelerator.

Example 15 provides the one or more non-transitory computer-readable media of any one of examples 12-14, where the instructions further cause the processor to: identify a first boundary task nodes separating the subgraph at index X-1 and the subgraph at index X; identify a second boundary task nodes separating the subgraph at index X and a subgraph at index X+1; determine that the second boundary task node does not depend on the first boundary task node; and add a dependency between the second boundary task node and the first boundary task node.

Example 16 provides the one or more non-transitory computer-readable media of example 15, where the processor adds the dependency by adding an edge to connect the first boundary task node to a virtual barrier node in the subgraph at index X that is immediately upstream of the second boundary task node.

Example 17 provides the one or more non-transitory computer-readable media of any one of examples 12-16, where the instructions further cause the processor to: add a barrier reprogramming task node in the subgraph at index X-1, the barrier reprogramming task node to reprogram the first subset of the hardware barriers used in the subgraph at index X.

Example 18 provides the one or more non-transitory computer-readable media of example 17, where the barrier reprogramming task node is added downstream of one or more virtual barrier nodes in the subgraph at index X-1 that synchronizes completion of one or more task nodes in a subgraph at index X-2.

Example 19 provides the one or more non-transitory computer-readable media of example 17 or 18, where the barrier reprogramming task node is added upstream of one or more virtual barrier nodes in the subgraph at index X that synchronizes completion of one or more task nodes in the subgraph at index X.

Example 20 provides the one or more non-transitory computer-readable media of any one of examples 12-19, where the instructions further cause the processor to: add a data movement task node in the subgraph at index X-1, the data movement task node to move one or more task descriptors associated with one or more task nodes in the subgraph at index X from a memory to a further memory of the neural network accelerator.

Example 21 provides the one or more non-transitory computer-readable media of example 20, where the data movement task node is added downstream of one or more virtual barrier nodes in the subgraph at index X-1 that synchronizes completion of one or more task nodes in a subgraph at index X-2.

Example 22 provides the one or more non-transitory computer-readable media of any one of examples 12-21, where the processing graph further includes one or more boundaries separating subgraphs and at least one of the one or more boundaries has two or more boundary task nodes.

Example 23 provides a method for compiling a neural network model to be executed on a neural network accelerator, the method including partitioning a processing graph representing the neural network model into one or more subgraphs, the one or more subgraphs being associated with a sequence of indices , where the processing graph has one or more task nodes and one or more virtual barrier nodes; performing a first assignment of one or more virtual barrier nodes of a subgraph at index X to a first subset of hardware barriers of the neural network accelerator; performing a second assignment of one or more further virtual barrier nodes of a subgraph at index X-1 to a second subset of the hardware barriers, where the first subset and the second subset are disjoint subsets; and generating a binary representation of the neural network model that is executable by the neural network accelerator according to the first assignment and the second assignment.

Example 24 provides the method of example 23, further including performing a third assignment of one or more yet further virtual barrier nodes of a subgraph at index X+1 to the second subset of the hardware barriers.

Example 25 provides the method of example 23 or 24, where partitioning the processing graph into subgraphs includes placing a boundary separating the subgraph at index X and the subgraph at index X-1 when the subgraph at index X has a number of virtual barriers that is equal to a threshold number of a number of the hardware barriers on the neural network accelerator.

Example 26 provides the method of any one of examples 23-25, further including identifying a first boundary task nodes separating the subgraph at index X-1 and the subgraph at index X; identifying a second boundary task nodes separating the subgraph at index X and a subgraph at index X+1; determining that the second boundary task node does not depend on the first boundary task node; and adding a dependency between the second boundary task node and the first boundary task node.

Example 27 provides the method of example 26, where adding the dependency includes adding an edge to connect the first boundary task node to a virtual barrier node in the subgraph at index X that is immediately upstream of the second boundary task node.

Example 28 provides the method of any one of examples 23-27, further including adding a barrier reprogramming task node in the subgraph at index X-1, the barrier reprogramming task node to reprogram the first subset of the hardware barriers used in the subgraph at index X.

Example 29 provides the method of example 28, where the barrier reprogramming task node is added downstream of one or more virtual barrier nodes in the subgraph at index X-1 that synchronizes completion of one or more task nodes in a subgraph at index X-2.

Example 30 provides the method of example 28 or 29, where the barrier reprogramming task node is added upstream of one or more virtual barrier nodes in the subgraph at index X that synchronizes completion of one or more task nodes in the subgraph at index X.

Example 31 provides the method of any one of examples 23-30, further including adding a data movement task node in the subgraph at index X-1, the data movement task node to move one or more task descriptors associated with one or more task nodes in the subgraph at index X from a memory to a further memory of the neural network accelerator.

Example 32 provides the method of example 31, where the data movement task node is added downstream of one or more virtual barrier nodes in the subgraph at index X-1 that synchronizes completion of one or more task nodes in a subgraph at index X-2.

Example 33 provides the method of any one of examples 23-32, where the processing graph further includes one or more boundaries separating subgraphs and at least one of the one or more boundaries has two or more boundary task nodes.

Example 34 provides an apparatus including means for performing a method according to any one of examples 23-33.

Example 32 provides a computer program product including instructions which, when executed by a processor, cause the processor to perform a method according to any one of examples 23-33.

Example 33 provides a machine-readable storage including machine-readable instructions, when executed, cause a computer to implement a method according to any one of examples 23-33.

Example 34 provides a computer program including instructions which, when the computer program is executed by a processing device, cause the processing device to carry out a method according to any one of examples 23-33.

Example 35 provides a computer-implemented system, including one or more processors, and one or more non-transitory computer-readable media storing instructions that, when executed by the one or more processors, cause the one or more processors to perform a method according to any one of examples 23-33.

### Variations and other notes

As used herein, the term "coupled to" or "coupled with" refers to a relationship between electronic components or circuit elements wherein the components are in electronic communication with one another and capable of transmitting and/or receiving electrical signals between them. The term "coupled to" does not require a direct physical or electrical connection between the coupled components. Rather, "coupled to" can encompass arrangements where the components are connected through one or more intervening elements, components, circuits, or transmission paths. For example, a first component may be "coupled to" a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase "A and/or B" means (A), (B), or (A and B). For the purposes of the present disclosure, the phrase “A, B, or C” or the phrase "A, B, and/or C" means (A), (B), (C), (A and B), (A and C), (B and C), or (A, B, and C). The term "between," when used with reference to measurement ranges, is inclusive of the ends of the measurement ranges.

The description uses the phrases "in an embodiment" or "in embodiments," which may each refer to one or more of the same or different embodiments. The terms "comprising," "including," "having," and the like, as used with respect to embodiments of the present disclosure, are synonymous. The disclosure may use perspective-based descriptions such as "above," "below," "top," "bottom," and "side" to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed is:

1. An apparatus for compiling a neural network model to be executed on a neural network accelerator, comprising:
a processor; and
a memory to store instructions, that when executed by the processor, cause the processor to:
partition a processing graph representing the neural network model into one or more subgraphs, the one or more subgraphs being associated with a sequence of indices, wherein the processing graph has one or more task nodes and one or more virtual barrier nodes;
perform a first assignment of one or more virtual barrier nodes of a subgraph at index X to a first subset of hardware barriers of the neural network accelerator;
perform a second assignment of one or more further virtual barrier nodes of a subgraph at index X-1 to a second subset of the hardware barriers, wherein the first subset and the second subset are disjoint subsets; and
generate a binary representation of the neural network model that is executable by the neural network accelerator according to the first assignment and the second assignment.

2. The apparatus of claim 1, wherein the instructions further cause the processor to:
perform a third assignment of one or more yet further virtual barrier nodes of a subgraph at index X+1 to the second subset of the hardware barriers.

3. The apparatus of claim 1, wherein the processor partitions the processing graph into subgraphs by:
placing a boundary separating the subgraph at index X and the subgraph at index X-1 when the subgraph at index X has a number of virtual barriers that is equal to a threshold number of the hardware barriers on the neural network accelerator.

4. The apparatus of claim 1, wherein the instructions further cause the processor to:
identify a first boundary task nodes separating the subgraph at index X-1 and the subgraph at index X;
identify a second boundary task nodes separating the subgraph at index X and a subgraph at index X+1;
determine that the second boundary task node does not depend on the first boundary task node; and
add a dependency between the second boundary task node and the first boundary task node.

5. The apparatus of claim 4, wherein the processor adds the dependency by adding an edge to connect the first boundary task node to a virtual barrier node in the subgraph at index X that is immediately upstream of the second boundary task node.

6. The apparatus of claim 1, wherein the instructions further cause the processor to:
add a barrier reprogramming task node in the subgraph at index X-1, the barrier reprogramming task node to reprogram the first subset of the hardware barriers used in the subgraph at index X.

7. The apparatus of claim 6, wherein the barrier reprogramming task node is added downstream of one or more virtual barrier nodes in the subgraph at index X-1 that synchronizes completion of one or more task nodes in a subgraph at index X-2.

8. The apparatus of claim 6, wherein the barrier reprogramming task node is added upstream of one or more virtual barrier nodes in the subgraph at index X that synchronizes completion of one or more task nodes in the subgraph at index X.

9. The apparatus of claim 1, wherein the instructions further cause the processor to:
add a data movement task node in the subgraph at index X-1, the data movement task node to move one or more task descriptors associated with one or more task nodes in the subgraph at index X from a memory to a further memory of the neural network accelerator.

10. The apparatus of claim 9, wherein the data movement task node is added downstream of one or more virtual barrier nodes in the subgraph at index X-1 that synchronizes completion of one or more task nodes in a subgraph at index X-2.

11. The apparatus of claim 1, wherein the processing graph further includes one or more boundaries separating subgraphs and at least one of the one or more boundaries has two or more boundary task nodes.

12. One or more non-transitory computer-readable media storing instructions for compiling a neural network model to be executed on a neural network accelerator, that when executed by a processor, cause the processor to:
partition a processing graph representing the neural network model into one or more subgraphs, the one or more subgraphs being associated with a sequence of indices, wherein the processing graph has one or more task nodes and one or more virtual barrier nodes;
perform a first assignment of one or more virtual barrier nodes of a subgraph at index X to a first subset of hardware barriers of the neural network accelerator;
perform a second assignment of one or more further virtual barrier nodes of a subgraph at index X-1 to a second subset of the hardware barriers, wherein the first subset and the second subset are disjoint subsets; and
generate a binary representation of the neural network model that is executable by the neural network accelerator according to the first assignment and the second assignment.

13. The one or more non-transitory computer-readable media of claim 12, wherein the instructions further cause the processor to:
perform a third assignment of one or more yet further virtual barrier nodes of a subgraph at index X+1 to the second subset of the hardware barriers.

14. The one or more non-transitory computer-readable media of claim 12, wherein the processor partitions the processing graph into subgraphs by:
placing a boundary separating the subgraph at index X and the subgraph at index X-1 when the subgraph at index X has a number of virtual barriers that is equal to a threshold number of the hardware barriers on the neural network accelerator.

15. The one or more non-transitory computer-readable media of claim 12, wherein the instructions further cause the processor to:
identify a first boundary task nodes separating the subgraph at index X-1 and the subgraph at index X;
identify a second boundary task nodes separating the subgraph at index X and a subgraph at index X+1;
determine that the second boundary task node does not depend on the first boundary task node; and
add a dependency between the second boundary task node and the first boundary task node.

16. The one or more non-transitory computer-readable media of claim 15, wherein the processor adds the dependency by adding an edge to connect the first boundary task node to a virtual barrier node in the subgraph at index X that is immediately upstream of the second boundary task node.

17. A method for compiling a neural network model to be executed on a neural network accelerator, the method comprising:
partitioning a processing graph representing the neural network model into one or more subgraphs, the one or more subgraphs being associated with a sequence of indices , wherein the processing graph has one or more task nodes and one or more virtual barrier nodes;
performing a first assignment of one or more virtual barrier nodes of a subgraph at index X to a first subset of hardware barriers of the neural network accelerator;
performing a second assignment of one or more further virtual barrier nodes of a subgraph at index X-1 to a second subset of the hardware barriers, wherein the first subset and the second subset are disjoint subsets; and
generating a binary representation of the neural network model that is executable by the neural network accelerator according to the first assignment and the second assignment.

18. The method of claim 17, further comprising:
adding a barrier reprogramming task node in the subgraph at index X-1, the barrier reprogramming task node to reprogram the first subset of the hardware barriers used in the subgraph at index X;
wherein:
the barrier reprogramming task node is added downstream of one or more virtual barrier nodes in the subgraph at index X-1 that synchronizes completion of one or more task nodes in a subgraph at index X-2; and
the barrier reprogramming task node is added upstream of one or more virtual barrier nodes in the subgraph at index X that synchronizes completion of one or more task nodes in the subgraph at index X.

19. The method of claim 17, further comprising:
add a data movement task node in the subgraph at index X-1, the data movement task node to move one or more task descriptors associated with one or more task nodes in the subgraph at index X from a memory to a further memory of the neural network accelerator; wherein the data movement task node is added downstream of one or more virtual barrier nodes in the subgraph at index X-1 that synchronizes completion of one or more task nodes in a subgraph at index X-2.

20. The method of claim 17, wherein the processing graph further includes one or more boundaries separating subgraphs and at least one of the one or more boundaries has two or more boundary task nodes.
